(19) United States
(12) Patent Application Publication
(10) Pub. No.: US 2016/0381565 A1
(43) Pub. Date: Dec. 29, 2016

(54) INTERFERENCE MITIGATION IN MULTI-PROVIDER WLAN NETWORKS

(71) Applicant: INERDIGITAL PATENT HOLDINGS, INC., Wilmington (DE)

(72) Inventors: Oghenekome Oteri, San Diego, CA (US); Xiaofei Wang, Cedar Grove, NJ (US); Fengjun Xi, San Diego, CA (US); Pengfei Xia, San Diego, CA (US); Nirav B. Shah, San Diego, CA (US); Robert L. Olesen, Huntington, NY (US); Monisha Ghosh, Chicago, IL (US)

(73) Assignee: InterDigital Patent Holdings, Inc., Wilmington, DE (US)

(21) Appl. No.: 15/039,437

(22) PCT Filed: Nov. 26, 2014
(86) PCT No.: PCT/US2014/067567

§ 371 Date: May 26, 2016

Related U.S. Application Data
(60) Provisional application No. 61/909,931, filed on Nov. 27, 2013.

(51) Int. Cl. H04W 16/14; H04W 28/18; H04W 84/12

(52) U.S. Cl. CPC H04W 16/14; H04W 84/12; H04W 28/18; H04W 74/0808

(57) ABSTRACT

Systems, methods, and apparatuses are disclosed for improving the efficiency of resource usage while facilitating transmission by multiple providers in a WLAN system. Information elements (lEs) may be used to coordinate among providers. Provider(s) may use an auction based method to contend for the channel. A provider may elect an auctioneer or auctioneers (e.g., Provider Coordinator(s)) that may broadcast a utility metric, performance-based (e.g., Network Throughput, Network Energy Level, Network Interference Level, Channel Selection Cost,etc.) or non-performance based (e.g., bid, payment, charge, preferred provider,etc). A granting entity, e.g., a central controller, may compare the utility metrics to determine a most favorable utility metric and grant access based on the most favorable utility metric, for example, to a provider associated with the most favorable utility metric. The provider with the most favorable utility metric may gain access (e.g., be granted access and gain access) to the channel. Provider contention may be considered as a contention at a first level, where a provider may contend for the channel using CSMA/CA. Nodes associated with a provider may contend for access (contention at a second level).

### CROSS-REFERNCE TO RELATED APPLICATIONS

This application claims the benefit of U.S. Provisional Application No. 61/909,931 filed Nov. 27, 2013, which is hereby incorporated by reference herein.

### BACKGROUND

A wireless local area network (WLAN) in an infrastructure Basic Service Set (BSS) mode may have an access point (AP) for a BSS and one or more stations (STAs) associated with the AP. The AP may have access to or an interface with a distribution system (DS) or another type of wired or wireless network that may carry traffic in and out of the BSS. Traffic to STAs that originates from outside the BSS may arrive through the AP and may be delivered to the STAs. Traffic originating from STAs to destinations outside the BSS may be sent to the AP to be delivered to the respective destinations. Traffic between STAs within the BSS may also be sent through the AP, where the source STA may send traffic to the AP and the AP may deliver the traffic to the destination STA. Such traffic between STAs within a BSS may be peer-to-peer traffic. Such peer-to-peer traffic may be sent directly between the source and destination STAs, for example, with a direct link setup (DLS) using an 802.11e DLS or an 802.11z tunneled DLS (TDLS). A WLAN using an Independent BSS (IBSS) mode may have no APs, and STAs and may communicate directly with other STAs. This mode of communication may be an ad hoc mode.

WLAN systems that may support multiple channels and channel widths, such as 802.11n, 802.11ac, 802.11af, and 802.11ah, may include a channel that may be designated as a primary channel. The primary channel may have a bandwidth equal to the largest common operating bandwidth supported by STAs in the BSS. The bandwidth of the primary channel may be affected by the STA, of the STAs operating in a BSS, which may support a smallest bandwidth operating mode. In 802.11ah, for example, the primary channel may be 1 MHz wide if there are STAs (e.g., MTC-type devices) that support (e.g., only support) a 1 MHz mode even if the AP and/or other STAs in the BSS may support a 2 MHz, 4 MHz, 8 MHz, 16 MHz, or other channel bandwidth operating modes. Carrier sensing and/or NAV settings may depend on the status of the primary channel. For example, if the primary channel is busy because a STA that supports only a 1 MHz channel bandwidth operating mode is transmitting to the AP, the entire available frequency bands may be considered busy even though the majority of the frequency bands may remain idle and available.

Heterogeneous networks may be deployed in the same physical area but under separate network management. The management entities may be different network providers operating separate public hotspots or private APs (e.g., homes or shops) that may leak outdoors. The private APs may be in a hidden node situation. In a high density deployment of hotspots, e.g., for increasing cellular offload or data deployment, interference from different providers may be severe and may negatively impact the network's spectral efficiency. Spectral capacity may be limited with overlapping BSSs due to spatial protection, interference, and/or lack of coordination with neighboring APs. Coordination may be feasible if APs belong to the same provider. With separate providers (e.g., operators or individual APs), coordination may become difficult within the framework of 802.11 networks.

### SUMMARY

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, and instrumentalities are disclosed for resource allocation. A network device (e.g., a central controller) may receive messages from provider coordinators contending for access to a medium. For example, the network device may receive a first message from a first IEEE 802.11 device and a second message from a second IEEE 802.11 device. The first IEEE 802.11 device may represent a first group of devices (e.g., stations (STAs) and/or APs) associated with a first provider and the second IEEE 802.11 device may represent a second group of devices (e.g., STAs and/or APs) associated with a second provider. The first and second IEEE 802.11 devices may contend for access to one or more channels (e.g., primary and/or secondary channels) via the first and second messages, e.g., the first IEEE 802.11 device may contend for access to the one or more channels for the first group of devices. The first IEEE 802.11 device and the second IEEE 802.11 device may be access points (APs).

The network device may determine a most favorable utility metric (e.g., between the first and second IEEE 802.11 devices and/or providers). For example, the first message may comprise a first utility metric and the second message may comprise a second utility metric. The network device may compare the two utility metrics to determine the most favorable utility metric. The network device may grant a resource to a provider associated with the most favorable utility metric. The resource may be access to one or more channels (e.g., access to a primary channel and/or secondary channel). The network device may receive contention-based resource requests from devices associated with the provider (e.g., in response to the granted resource). The contention-based resource requests may be legacy contention-based resource requests (e.g., contention-based resource requests in conformance with 802.11ac or earlier specifications). A utility metric may be performance or non-performance based.

The most favorable utility metric may map to a clear channel assessment (CCA) threshold, e.g., a higher utility metric may map to a lower CCA threshold level on one or more channels, which may result in lower average throughput and higher sensitivity to interference.

The first message may be received in response to the network device sending a coordination request to the first IEEE 802.11 device (e.g., the first IEEE 802.11 device receiving the coordination request). The coordination request may be made via an information element, e.g., the information element may identify a metric to be provided. The first message may include an indication that the first IEEE 802.11 device is a provider coordinator associated with the first provider. The indication that the first IEEE 802.11 device is a provider coordinator may be provided in an information element. A first field of the information element may identify an address associated with the provider coordinator. A second field of the information element may identify the first provider associated with the provider coordinator.

Systems, methods, and instrumentalities are disclosed for improving the efficiency of resource usage while facilitating transmission by multiple providers in a WLAN system. Secondary channel access may be allowed for a provider in a primary channel of another provider in the WLAN system. For example, a primary channel for one provider may be a secondary channel for another provider, and vice versa. The primary channels and secondary channels for the providers may overlap, e.g., may be identical. Transmission on the primary and secondary channels may be based on primary and secondary channel access priorities, and the system may modify channel access priorities on the primary and secondary channels for each provider.

Contention windows may be selected for multiple providers with multiple backoff window sizes and/or inter-frame spacings. Secondary channel transmission may be performed on a priority basis with adjustable inter-frame spacing, backoff duration, and/or CCA threshold and/or secondary RTS/CTS reservations. Information elements (IEs), such as Provider Coordinator IEs and Coordination Request/Response IEs, may be used to coordinate among providers on various parameters. A multi-level or hierarchical carrier sensing mechanism may be used to reduce the effect of a high number of STAs per AP, enable channel reuse, and/or enhance cooperation among providers.

Interference in a WLAN network comprising a plurality of providers may be mitigated by selecting, for a provider, a first contention window size and a first inter-frame spacing (IFS) for single band transmission and a second contention window size and a second IFS for dual band transmission. Single band transmission or dual band transmission may be selected as a function of at least one of the first contention window size, the first IFS, the second contention window size, or the second IFS. At least one of these values may be communicated to another provider of the plurality of providers.

A transmission priority of a transmission in a channel in a WLAN network comprising a plurality of providers may be modified by sending a first prioritization parameter for the channel from a first provider to a second provider. A second prioritization parameter for the channel may be received at the first provider from the second provider. At least one of the first prioritization parameter or the second prioritization parameter may be communicated to a node of the WLAN network. Carrier Sense Multiple Access with Collision Avoidance (CSMA/CA) may be performed as a function of at least one of the first prioritization parameter or the second prioritization parameter.

### BRIEF DESCRIPTION OF THE DRAWINGS

FIG. 1 illustrates an exemplary WiFi local area network (WLAN) system.

FIG. 2 illustrates an example coordination request information element (IE).

FIG. 3 illustrates an example coordination response IE.

FIG. 4 illustrates an example assignment of providers in a multi-provider network to orthogonal frequency bands.

FIG. 5 illustrates example overlapping primary and secondary channels in a multi-provider network.

FIG. 6 illustrates example identical primary and secondary channels in a multi-provider network.

FIG. 7 illustrates an example of primary and secondary channel operation in a multi-provider network.

FIG. 8 illustrates an example of channel allocation across multiple channels.

FIG. 9 illustrates example inter-frame spacing and contention windows (e.g., backoff) for primary channel use and for primary and secondary channel use.

FIG. 10 illustrates an example of adaptive xIFS for a provider in a multiple-provider network.

FIG. 11 illustrates an example of secondary RTS/CTS transmission in a multi-provider network.

FIG. 12 illustrates an example of secondary RTS/CTS transmission with backoff-based prioritization.

FIG. 13 illustrates an example of secondary RTS/CTS transmission with backoff-based prioritization for independent channels.

FIG. 14 illustrates an example of secondary RTS/CTS with inter-frame spacing-based prioritization.

FIG. 15 is a block diagram illustrating an example transmitter with a bit-level interference mitigation scrambler per codeword.

FIG. 16 is a block diagram illustrating an example transmitter with a bit-level interference mitigation scrambler per stream.

FIG. 17 illustrates an example interference mitigation interference operation field.

FIG. 18 illustrates an example HE WLAN frame structure for interference mitigation scrambling.

FIG. 19 illustrates an example of coexistence of HE WLAN-MF and legacy stations.

FIG. 20 illustrates an example interference mitigation scrambling information element (IE).

FIG. 21 illustrates an example Provider Coordinator information element (IE).

FIG. 22 illustrates an example Coordination Request IE.

FIG. 23 illustrates an example Coordination Response IE.

FIG. 24 illustrates an example of hierarchical multi-provider network access with independent channel access.

FIG. 25 illustrates an example of hierarchical multi-provider network access with secondary channel access.

FIG. 26A is a system diagram of an example communications system in which one or more disclosed embodiments may be implemented.

FIG. 26B is a system diagram of an example wireless transmit/receive unit (WTRU) that may be used within the communications system illustrated in FIG. 26A.

FIG. 26C is a system diagram of an example radio access network and an example core network that may be used within the communications system illustrated in FIG. 26A.

FIG. 26D is a system diagram of another example radio access network and another example core network that may be used within the communications system illustrated in FIG. 26A.

FIG. 26E is a system diagram of another example radio access network and another example core network that may be used within the communications system illustrated in FIG. 26A.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

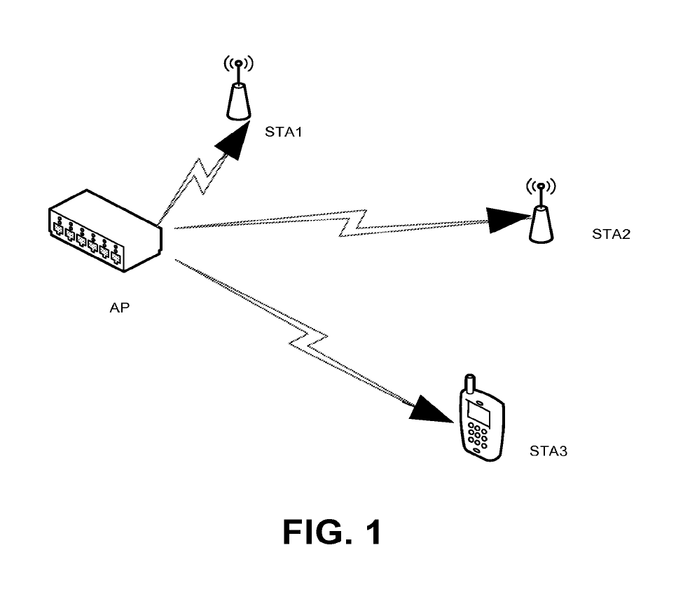

A WLAN in infrastructure basic service set (BSS) mode may have an access point (AP) for the basic service set (BSS) and one or more stations (STAs) associated with the AP as illustrated by way of example in FIG. 1. The AP may have access or interface to a Distribution System (DS) or another type of wired/wireless network that may carry traffic in and out of the BSS. Traffic to STAs may originate from outside the BSS, may arrive through the AP and may be delivered to the STAs. The traffic originating from STAs to destinations outside the BSS may be sent to the AP to be delivered to the respective destinations. Traffic between STAs within the BSS may be sent through the AP where the source STA may sends traffic to the AP and the AP may deliver the traffic to the destination STA. The traffic between STAs within a BSS may be peer-to-peer traffic. Such peer-to-peer traffic may be sent directly between the source and destination stations, e.g., with a direct link setup (DLS) using an IEEE 802.11e DLS or an IEEE 802.11z tunneled DLS (TDLS). A WLAN using an Independent BSS (IBSS) mode may have no APs, and the STAs may communicate directly with each other. This mode of communication may be an ad hoc mode.

In an 802.11ac infrastructure mode of communication, an AP may transmit a beacon on a fixed channel, for example, the primary channel. The channel may be 20 MHz wide and may be an operating channel of the BSS. The channel may be used by the STAs to establish a connection with the AP. Carrier Sense Multiple Access with Collision Avoidance (CSMA/CA) may be used for channel access in an 802.11 system. In CSMA/CA, STAs (e.g., every STA), including the AP, may sense the primary channel. If the channel is detected to be busy, the STA may back off One STA (e.g., only one STA) may transmit at a given time in a given BSS.

In 802.11n, High Throughput (HT) STAs may use a 40 MHz wide channel for communication. This may be achieved by combining a primary 20 MHz channel with an adjacent 20 MHz channel to form a 40 MHz wide contiguous channel.

In 802.11ac, Very High Throughput (VHT) STAs may support 20 MHz, 40 MHz, 80 MHz, and/or 160 MHz wide channels. The 40 MHz and 80 MHz channels may be formed by combining contiguous 20 MHz channels. A 160 MHz channel may be formed, for example, by combining eight contiguous 20 MHz channels or by combining two non-contiguous 80 MHz channels in an 80+80 configuration. In an 80+80 configuration, data, after channel encoding, may be passed through a segment parser that may divide it into two streams, e.g., IFFT and time domain. Processing may be performed on each stream separately. The streams may be mapped onto the two channels, and the data may be transmitted. The mechanism may be reversed at the receiver, and the combined data may be sent to the MAC.

IEEE 802.11af and IEEE 802.11ah may support sub 1 GHz modes of operation. For these specifications the channel operating bandwidths may be reduced relative to those used in IEEE 802.11n, and IEEE 802.11ac. IEEE 802.11af may support 5 MHz, 10 MHz and/or 20 MHz bandwidths in the TV White Space (TVWS) spectrum, and IEEE 802.11ah may support 1 MHz, 2 MHz, 4 MHz, 8 MHz, and/or 16 MHz bandwidths, e.g., using non-TVWS spectrum. IEEE 802.11ah may support Meter Type Control (MTC) devices in a macro coverage area. MTC devices may have capabilities including, for example, support for limited bandwidths, and a requirement for a very long battery life.

WLAN systems that may support multiple channels and channel widths, such as 802.11n, 802.11ac, 802.11af, and 802.11ah, may include a channel that may be designated as a primary channel. The primary channel may have a bandwidth equal to the largest common operating bandwidth supported by STAs in the BSS. The bandwidth of the primary channel may be affected by the STA, of the STAs operating in a BSS, which may support a smallest bandwidth operating mode. In 802.11ah, for example, the primary channel may be 1 MHz wide if there are STAs (e.g., MTC-type devices) that support (e.g., only support) a 1 MHz mode even if the AP and/or other STAs in the BSS may support a 2 MHz, 4 MHz, 8 MHz, 16 MHz, or other channel bandwidth operating modes. Carrier sensing and/or NAV settings may depend on the status of the primary channel. For example, if the primary channel is busy because a STA that supports only a 1 MHz channel bandwidth operating mode is transmitting to the AP, the entire available frequency bands may be considered busy even though the majority of the frequency bands may remain idle and available.

In the United States, for example, the available frequency bands that may be used by IEEE 802.11ah may be from 902 MHz to 928 MHz. In Korea, for example, it may be from 917.5 MHz to 923.5 MHz. In Japan, for example, it may be from 916.5 MHz to 927.5 MHz. The total bandwidth available for IEEE 802.11ah may be 6 MHz to 26 MHz and may depend on the country code.

New spectrum is being allocated in various countries for wireless communication systems, such as WLANs. Channels allocated in this spectrum may be limited, for example, in size and bandwidth. The spectrum may be fragmented, e.g., available channels may not be adjacent, and it may not be possible to combine them to support larger transmission bandwidths. This may be the case, for example, in spectrum allocated below 1 GHz in various countries. WLAN systems, for example, built on the 802.11 standard, may be designed to operate in this spectrum. Such WLA systems may support smaller bandwidths and lower data rates compared to HT/VHT WLAN systems, for example, based on the 802.11n/802.11ac standards.

The IEEE 802.11ah Task Group (TG) has been established to develop solutions to support WiFi systems in the sub-1 GHz band. The 802.11ah TG is targeting to achieve an OFDM physical layer (PHY) operating below 1 GHz in license-exempt bands excluding TVWS, enhancements to MAC to support PHY and coexistence with other systems (e.g., 802.15.4 and P802.15.4g), and balancing of rate and range performance (e.g., outdoor range of up to 1 km and data rates greater than 100 Kbit/s). Use cases may include sensors and meters, backhaul sensor and meter data, and/or extended range WiFi for cellular offloading.

Spectrum allocation in some countries may be limited. For example, in China, the 470-566 and 614-787 MHz bands allow 1 MHz bandwidth. A 1 MHz-only option may be supported, in addition to a 2 MHz mode. The 802.11ah PHY may support 1, 2, 4, 8, and 16 MHz bandwidths.

The 802.11ah PHY may operate below 1 GHz and is based on the 802.11ac PHY. To accommodate the narrow bandwidths used by 802.11ah, the 802.11ac PHY may be down clocked by a factor of 10. While support for 2, 4, 8, and 16 MHz bandwidths may be achieved by 1/10 downclocking, support for the 1 MHz bandwidth may use a PHY definition with an FFT size of 32.

IEEE 802.11 High-Efficiency (HE) WLAN may enhance the Quality of Experience (QoE) for a broad spectrum of wireless users in many usage scenarios, including high-density scenarios in the 2.4 GHz and 5 GHz bands. Some use cases may support dense deployments of APs, and STAs, and associated Radio Resource Management (RRM) technologies.

Potential applications for HE WLAN may include emerging usage scenarios such as data delivery for stadium events, high user density scenarios (e.g., train stations, enterprise/retail environments, video delivery, and the like), and wireless services for medical applications. HE WLAN may be used in applications involving a high density of APs and a large number of STAs per AP. HE WLAN may be used in indoor applications involving a high density of STAs. HE WLAN may be used in indoor applications involving a high density of APs (e.g., with a low or medium density of STAs per AP) or in outdoor applications involving a high density of APs (e.g., with a high density of STAs per AP). HE WLAN may be used in throughput-demanding applications. Technologies that support a large number of devices may be involved in one or more of these applications. Reduction of contention may provide high efficiency for HE WLAN systems.

Heterogeneous networks may be deployed in the same physical area but under separate network management. The management entities may be different network providers operating separate public hotspots or private APs (e.g., homes or shops) that may leak outdoors. The private APs may be in a hidden node situation. In a high density deployment of hotspots, e.g., for increasing cellular offload or data deployment, interference from different providers may be severe and may negatively impact the network's spectral efficiency. Spectral capacity may be limited with overlapping BSSs due to spatial protection, interference, and/or lack of coordination with neighboring APs. Coordination may be feasible if APs belong to the same provider. With separate providers (e.g., operators or individual APs), coordination may become difficult within the framework of 802.11 networks. 802.11 specifications may not provide further support for a common network coordination entity.

A network may or may not have a large number of STAs. Multiple providers in the network may or may not be co-located. For example, in airports or cellular tower sharing, co-location of different providers may be feasible. The network efficiency of dense heterogeneous networks with a large number of APs and with or without a large number of STAs may be improved.

Inter-AP coordination may be used to conduct coordination for a variety of parameters and settings for overlapping basic service set (OBSS), including, for example, QoS load and settings, primary and coordination channels, transmit opportunity (TxOP), and/or uplink (UL) access and TIM indications.

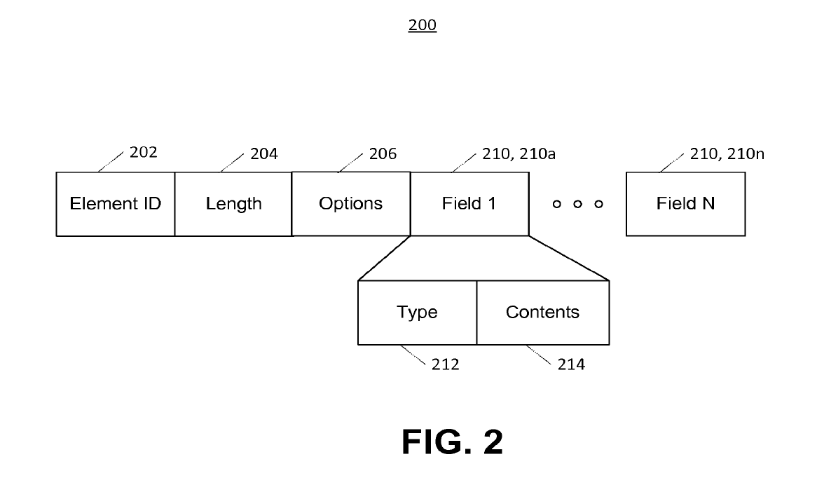

FIG. 2 illustrates an example coordination request information element (IE) 200. Coordination request IE 200 may be sent from a first AP to a second AP. The coordination request IE 200 may include one or more of the following fields. An element identification (ID) field 202 may identify the coordination request IE 200, for example the element ID field 202 may indicate that the coordination request IE 200 is a coordination request information element. A length field 204 may indicate a length of the coordination request IE 200. An option field 206 may indicate the type of information that the coordination request IE 200 includes. The option field 206 may be implemented as binary numbers to indicate the option. The option field 206 may be include a bit map to indicate the type of information included in the coordination request IE 200. The option field 206 may include a sequence number identifying the coordination request IE. The option field 206 may include an indication of the number of fields included in the coordination request IE 200. The coordination request IE 200 may include additional fields 210a . . . 210n. Each additional field 210 may include a field type 212 and a field content 214. The field type 212 may indicate a type of content stored in the field content 214.

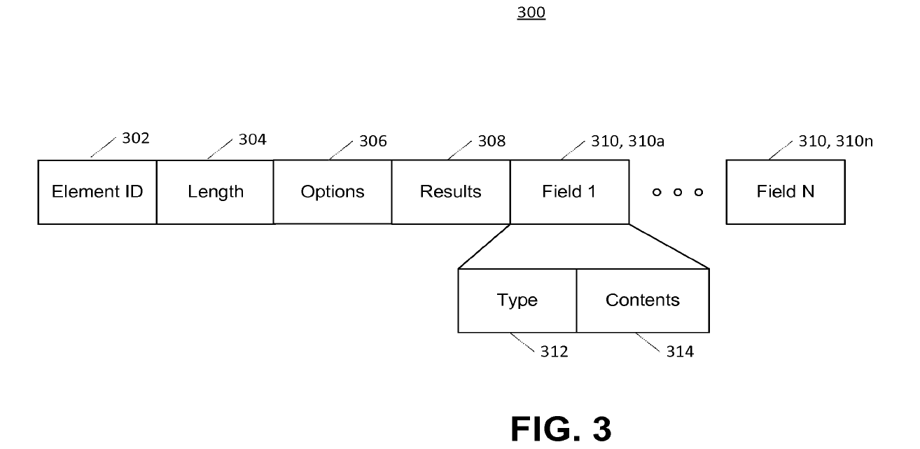

FIG. 3 illustrates an example coordination response IE 300. The coordination response IE 300 may be sent from one AP to another AP. For example, the coordination response IE 300 may be sent by the second AP to the first AP in response to the second AP receiving the coordination request IE 200 from the first AP. The coordination response IE 300 may include one or more of the following fields: an element ID field 302, a length field 304, an option field 306, a results field 308 and other fields 310. The coordination response IE 300 may include fewer or more fields than the coordination request IE 200. For example, the coordination response IE 300 may include the results field 308. The results field 308 may indicate a status of the coordination request IE 200. The results field 308 may have potential values of Success, Reject, or Alternative values. The results field 308 may provide information on current settings and parameters requested. Interference and neighboring BSS reporting may be used as part of an inter-BSS coordination process.

Bit-level scrambling may be used to randomize interference between cells and/or between wireless transmit/receive units (WTRUs). Interference mitigation scrambling operations may be introduced, for example, by applying different scrambling sequences to different transmitters. An interference mitigation scrambler may be applied after channel coding. The scrambled signal may be descrambled at the receiver to randomize the interference from different transmitters and mitigate it. By applying different scrambling sequences for different transmitters, interfering signals from other transmitters after descrambling may be randomized and mitigated. This may be different from a WiFi scrambler that may be found before a channel coding block. The WiFi scrambler may remove long strings of 1s and 0s to make clock recovery easier.

Multiple providers in a multi-provider network may be allocated different frequency channels, e.g., channels may be reused. For example, orthogonal selection of a primary bandwidth may use bandwidth increase and/or fallback (see, e.g., 802.11ac 22.3.19.5.4 for CCA rules with primary and secondary channels and 802.11ac 9.19.2.8 for EDCA access rules with primary and secondary channels).

Channel reuse may be difficult because co-channel interference may limit spatial capacity and may result in increased interference. Channel reuse may be difficult in environments in which Line-of-Sight (LOS) propagation may be very good. Even when there may be enough channels to allocate a separate frequency to each provider, the dense deployment of APs within each provider may result in inefficient reuse of resources if each provider is limited to orthogonal frequency channels. The efficiency of resources may be improved while allowing transmission by multiple providers on primary and/or secondary channels.

In dense networks, gains may be achieved by managing the network. This may be done, for example, in WiFi infrastructure networks, which may be found in offices or in WiFi hotspots managed by a single provider. However, the presence of private APs, such as in homes or shops, tethering devices such as soft APs, and/or devices that may use WiFi direct services, may reduce the ability to manage these networks. Unmanaged devices may be seen as independent providers. The effect of these unmanaged devices or independent providers on the performance of managed networks may be reduced.

In dense networks, a large number of APs from multiple providers may be deployed over an area, with a potentially large number of STAs associating with each AP. The aggregated traffic from all STAs and all APs may be so voluminous that the aggregated throughput as well as the average performance per STA may be severely reduced due to limited resources and excessive contentions for the wireless medium. In addition, STAs may be provided service according to their service criteria despite the dense deployment and large number of STAs present. A mechanism may be used to provide a sufficient level of service for STAs in dense multiple provider deployments.

In networks with multiple providers, e.g., when each provider may have multiple BSSs deployed in the same region, it may be difficult to coordinate among providers to achieve consistent and flexible admission control, load balancing, and/or fairness behavior to control (e.g., optimize) the networks. This may be true even when the APs for the different providers are co-located, such as in airports or in cellular tower co-location deployments. To enhance multi-provider cooperation, multiple providers may exchange information regarding other providers and may adapt multi-provider network parameters.

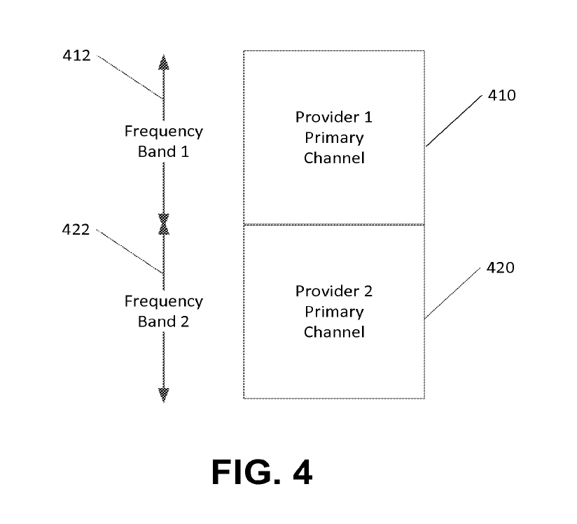

FIG. 4 illustrates an example assignment of channels to providers in a multi-provider network. Providers may be assigned (e.g., independently) to separate frequency bands, which may be orthogonal. A channel 410 may span over a frequency band 412. Another channel 420 may span over another frequency band 422. The channel 410 may be assigned to provider 1 and the channel 410 may be designated as a primary channel for provider 1. The channel 420 may be assigned to provider 2 and the channel 420 may be designated as a primary channel for provider 2. As illustrated, separate (e.g., orthogonal) frequency bands 412, 422 may be assigned to the providers 1, 2. A provider may use the channel assigned as the primary channel for the provider and not any other channels. For example, provider 1 may use channel 410 and not channel 420. The configuration illustrated in FIG. 4 may be an inefficient use of resources, for example, when provider 1 may not have information to transmit, and the frequency band 412 may be underutilized. A channel may be designated as a primary channel for one provider and a secondary channel for another provider, which may improve efficiency. For example, the channel 410 may be assigned as a primary channel for provider 1 and a secondary channel for provider 2. The channel 420 may be assigned as a primary channel for provider 2 and a secondary channel for provider 1. The primary channels assigned to the providers 1 and 2 may not overlap.

In IEEE 802.11n systems, if an incoming AP starts 20/40 MHz transmission in a frequency band that is occupied by a 20/40 MHz BSS, the incoming AP may ensure that its primary and secondary bands match the BSS. If there are multiple BSSs with non-matching primary and secondary bands, the incoming AP may set its primary and secondary channels without ensuring that its primary and secondary bands match a BSS. This criterion was relaxed in IEEE 802.11ac systems.

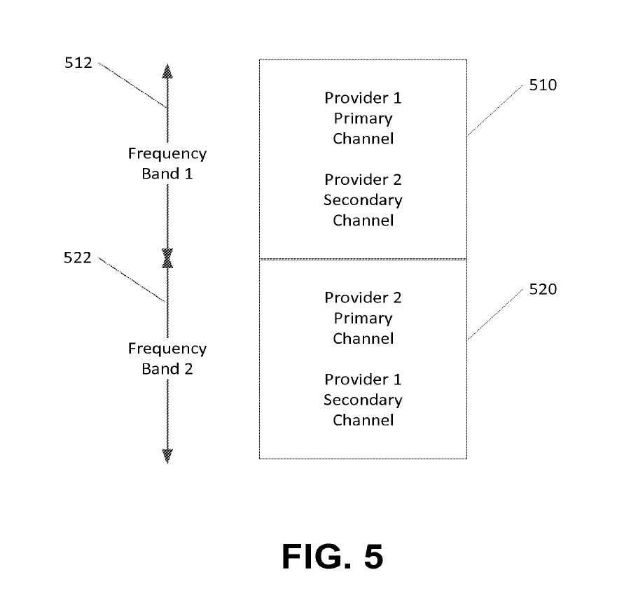

FIG. 5 illustrates an example channel assignment where a primary channel for a first provider may overlap a secondary channel for a second provider. As shown in FIG. 5, a channel 510 that may occupy a frequency band 512 may be designated as a primary channel for provider 1 and a secondary channel for provider 2. A channel 520 that may occupy a frequency band 522 and may be designated as a primary channel for provider 2 and a secondary channel for provider 1. In the designation of a secondary channel for a provider, the primary and secondary channels may be non-adjacent, and a provider may have multiple secondary channels. For example, a provider may have a transmission bandwidth of 80 MHz in a 20+20+20+20 configuration with one or more (e.g., all) bands non-adjacent. Selection of the secondary channel may be based on one or more considerations.

A central controller (e.g., a network entity, an AP, a designated controller, a provider coordinator, etc.) with knowledge of the network may communicate the channel allocation to a provider AP, e.g., as disclosed herein. This may be done, for example, through a backhaul connection or by an over-the-air frame. A provider AP may connect to a centralized controller or database to deliver or obtain the information. The central controller may have full or partial knowledge of the network. Network information may include one or more of the following: the channels and their current loading, the number of providers, their traffic load, their node distribution, and/or the channel interference profile.

The provider AP may decide (e.g., independently) on its secondary channels based on the amount of traffic the provider AP estimates in the frequency band. Secondary channel selection may be based on an estimation of the interference in the channel (e.g., PHY layer estimation) or from dedicated MAC layer frames broadcast by neighboring APs or providers indicating the traffic load (e.g., MAC layer estimation).

A database, which may be centrally located, may be available. The database may provide resource allocation information, e.g., to provider APs. The database may advertise its existence using a management frame, such as a beacon frame. A provider AP may access the database for information regarding a channel. The provider AP may use the information to determine whether to use the channel as a secondary channel. For example, provider 1 may query the database for information regarding usage of channel 2 (e.g., how often provider 2 uses the channel 520). Provider 1 may select the channel 520 as a secondary channel for provider 1 based on the queried information, for example when usage is below a threshold.

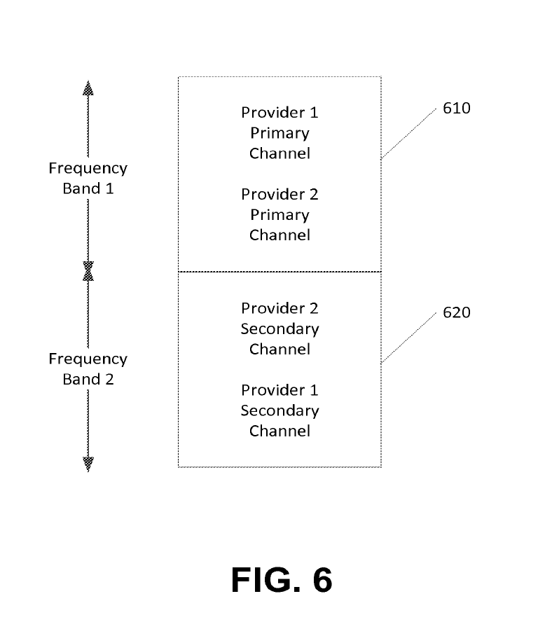

FIG. 6 illustrates an example channel assignment. In the example of FIG. 6, providers 1 and 2 are assigned a channel 610 as the primary channel and a channel 620 as the secondary channel. The primary channel assigned to providers 1 and 2 may overlap but may not be identical. The primary channel assigned to provider 1 may be identical to the primary channel assigned to provider 2 and the secondary channel assigned to provider 1 may be identical to the secondary channel assigned to provider 2. Allocation of the primary channel and the secondary channel and corresponding parameters between providers may be selected and announced or signaled as disclosed herein.

Data transmission by a provider may occur on the primary and/or secondary channels assigned to the provider. The primary channel may be the channel that the 802.11 control channels may use, such as the beacon, probe requests, and/or responses, and the like. A secondary channel may be a channel that is allocated to a STA and that is not a primary channel. One or more secondary channels may be allocated to a particular STA to enable the STA to transmit data using a higher bandwidth. Channel access timing on the secondary channel, or multiple secondary channels, may be based wholly or in part on a Clear Channel Assessment (CCA) of the primary channel. The CSMA backoff may be performed within the primary channel, while associated transmissions may be performed on the secondary channel, for example if there is no activity on the secondary channel for a PCF IFS (PIFS) duration before the backoff counter on the primary channel expires. Transmission may occur on the primary channel or may be canceled, depending on the network configuration, for example if the secondary channel is busy.

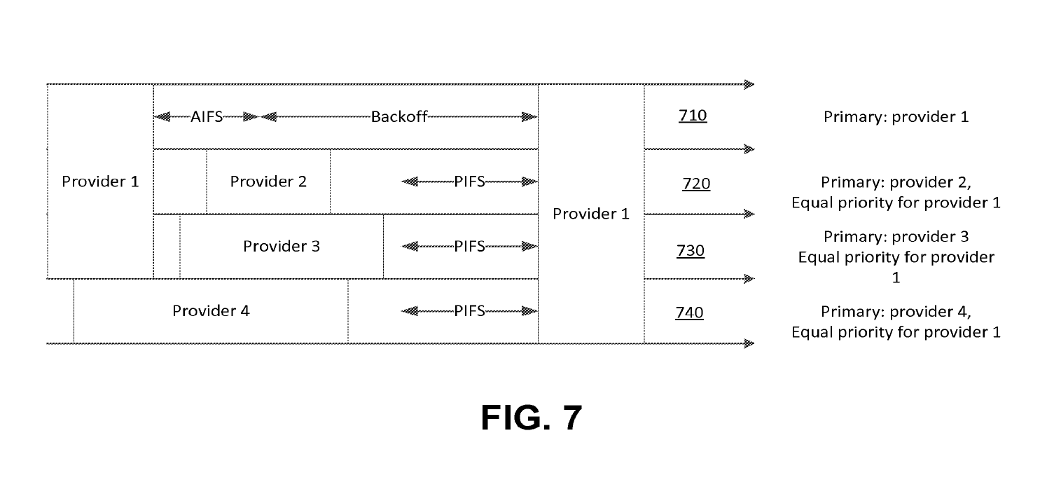

FIG. 7 illustrates an example of primary and secondary channel operation in a multi-provider network, e.g., the channel allocations may be assigned, negotiated, determined, etc. In the example of FIG. 7, transmission on the primary and secondary channels may be based on primary channel access priorities. For example, secondary channel access for provider 1 may be passive and dependent on the access priorities of provider 2 (e.g., providers may have different access priorities on different channels). Primary provider (e.g., provider 2) and secondary provider (e.g., provider 1) for a given channel (e.g., channel 720) may interact (e.g., via provider coordinators), and the system (e.g., central controller, for example a network entity) may modify channel access priorities on the primary and secondary access channels (e.g., channels 710 and 720) for each provider (e.g., providers 1 and 2), This may be done based on network traffic demands, channel conditions, fairness among providers, etc.

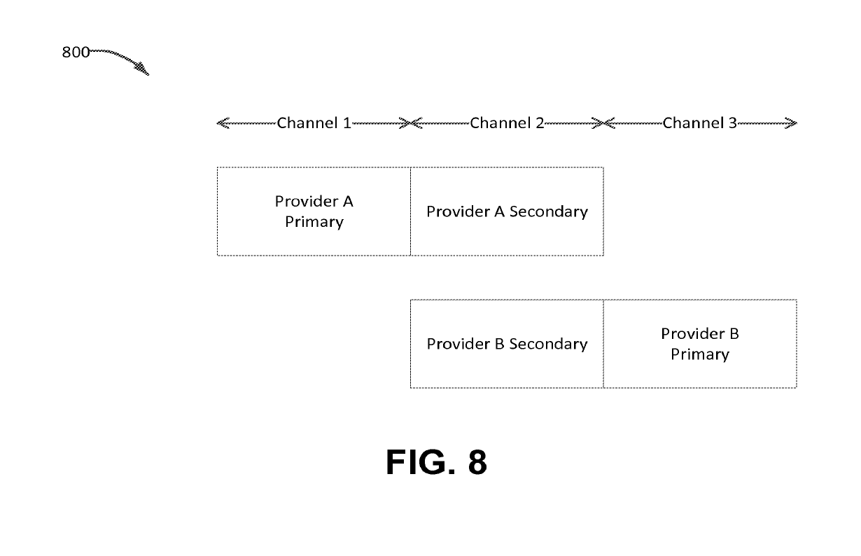

A multi-provider contention window may use multiple backoff window sizes and/or inter-frame spacings. FIG. 8 illustrates an example of a channel allocation 800 across multiple (e.g., three) channels. In the example of FIG. 8, two providers A and B may access multiple channels 1, 2, and/or 3. Provider A may have channel 1 as a primary channel, provider B may have channel 3 as a primary channel. Providers A and B may have channel 2 as a secondary channel. Providers A and B may share channel 2 as a secondary channel.

The provider may select to use the provider's primary channel (e.g., only the primary channel), or the provider may select to use the provider's primary channel along with one or more of the provider's secondary channels, which may be shared with another provider. For example, provider A may use channel 1 or channels 1 and 2. The probability of a provider using the provider's primary channel or the provider's primary and secondary channels may depend on network settings. The selection described may apply for each provider.

Different providers may use different contention window sizes to attempt a single band transmission over a primary channel, or a dual band transmission over its primary and secondary channels. Different providers may use different inter-frame spacings to attempt a single band transmission over its primary channel or a dual non-contiguous band transmission over its primary and secondary channels. Channel access may include one or more of the following.

Provider A may select a contention window size T_{A1} on its primary channel 1 (e.g., to facilitate single band transmission on its primary channel 1). Provider A may select a contention window size T_{A2} on its primary channel 1 and secondary channel 2 (e.g., to facilitate dual band transmission on the primary and secondary channels). Provider A may generate random number(s) in its single band contention window (e.g., T_{A1}) and/or its dual band contention window (e.g., T_{A2}). Provider A may determine which transmission (single band transmission or dual band transmission) to attempt. Provider B may generate random number(s) in its single band contention window (e.g., T_{B1}) and/or its dual band contention window (e.g., T_{B2}). Provider B may determine which transmission (e.g., single band transmission or dual band transmission) to attempt. Providers A and/or B may perform carrier sensing multiple access with collision avoidance (CSMA/CA) over its selected band.

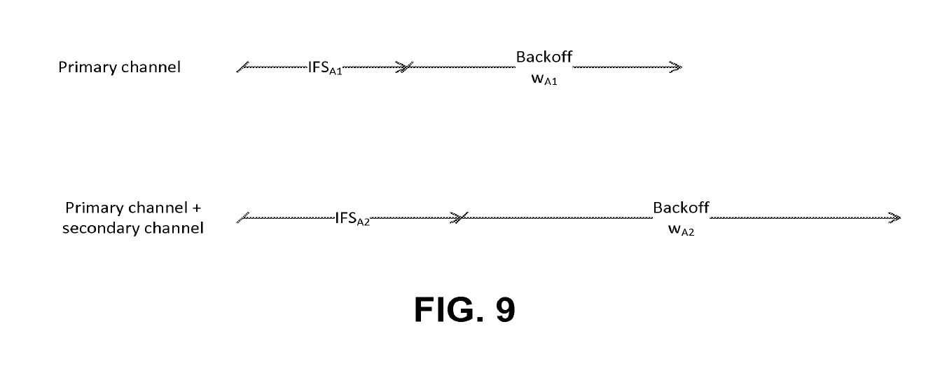

Provider A may select a contention window size T_{A1} on provider A's primary channel (e.g., channel 1), for example to facilitate single band transmission on primary channel 1. Provider B may select a contention window size T_{B1} on provider B's primary channel (e.g., channel 3), for example to facilitate single band transmission on primary channel 3. Provider A may select an inter-frame spacing IFS_{A1} on its primary channel, e.g., as shown in FIG. 9. Provider B may select an inter-frame spacing IFS_{B1} on its primary channel.

Provider A may select a contention window size T_{A2} on provider A's primary and secondary channels, for example to facilitate dual band transmission on provider A's primary and secondary channels (e.g., channels 1 and 2). Provider B may select a contention window size T_{B2} on provider B's primary and secondary channels, for example to facilitate dual band transmission on provider B's primary and secondary channels (e.g., channels 3 and 2). Provider A may have a higher probability of using provider A's single band transmission than using provider A's dual band transmission, for example if T_{A1}≦T_{A2}. Provider B may have a higher probability of using provider B's single band transmission than using provider B's dual band transmission, for example if T_{B1}≦T_{B2}. Provider A may select an inter-frame spacing IFS_{A2} on provider A's primary and secondary channels (e.g., channels 1 and 2), see also FIG. 9. Provider B may select an inter-frame spacing IFS_{B2} on provider B's primary and secondary channels (e.g., channels 3 and 2).

Provider A may generate random, or pseudo-random, numbers in provider A's single band contention window and in provider A's dual band contention window. Provider A may determine which transmission (e.g., single band or dual band) to attempt. For example, provider A may generate a random, or pseudo-random, number in provider A's single band contention window T_{A1} to determine a random backoff w_{A1}=uniform[0, T_{A1}) for provider A's single band contention window. Provider A may generate (e.g., also generate) a random number in provider A's dual band contention window T_{A2} to determine a random backoff w_{A2}=uniform[0, T_{A2}) for provider A's dual band contention window. Provider A may resolve (e.g., internally resolve) whether to attempt a single band transmission over channel 1 or to attempt a dual band transmission over channels 1 and 2. For example, not considering the IFS difference, provider A may determine to attempt a single band transmission over channel 1, for example if w_{A1}≦w_{A2}. Provider A may determine to attempt a dual band transmission over channels 1 and 2, for example if w_{A1}>w_{A2}. Considering the IFS difference, provider A may determine to attempt a single band transmission over channel 1, for example if w_{A1}+IFS_{A1}≦w_{A2}+IFS_{A2}. Provider A may determine to attempt a dual band transmission over channels 1 and 2, for example if w_{A1}+IFS_{A1}>w_{A2}+IFS_{A2},

Provider B may generate random, or pseudo-random, numbers in provider B's single band contention window and in provider B's dual band, or non-contiguous band, contention window. Provider B may determine which transmission (e.g., single band or dual band) to attempt. For example, provider B may generate a random number in provider B's single band contention window T_{B1} to determine a random backoff w_{B1}=uniform[0, T_{B1}) for provider B's single band contention window T_{B1}. Provider B may generate (e.g., also generate) a random number in provider B's dual band contention window T_{B2} to determine a random backoff w_{B2}=uniform[0, T_{B2}) for provider B's dual band contention window T_{B2}. Provider B may resolve (e.g., internally resolve) whether to attempt a single band transmission, e.g., over channel 3, or to attempt a dual band transmission, e.g., over channels 3 and 2. For example, not considering the IFS difference, provider B may determine to attempt a single band transmission over channel 3, for example, if w_{B1}≦w_{B2}. Provider B may determine to attempt a dual band transmission over channels 3 and 2, for example if w_{B1}>w_{B2}. Considering the IFS difference, provider B may determine to attempt a single band transmission over channel 3, for example if w_{B1}+IFS_{B1}≦w_{B2}+IFS_{B2}. Provider B may determine to attempt a dual band transmission over channels 3 and 2, for example if w_{B1}+IFS_{B1}>w_{B2}+IFS_{B2}.

Providers A and B may perform carrier sensing multiple access with collision avoidance (CSMA/CA) over provider's A and B's selected bands. If provider A selects to attempt a single band transmission, provider A may listen on provider A's primary channel (e.g., channel 1) for a time duration (e.g., w_{A1}+IFS_{A1}) and transmit if the channel is idle within the time duration. If provider B selects to attempt a single band transmission, provider B may listen on provider B's primary channel (e.g., channel 3) for a time duration (e.g., w_{B1}+IFS_{B1}) and transmit if the channel is idle within the time duration. If provider A selects to attempt a dual band transmission, provider A may listen on provider A's primary and secondary channels (e.g., channels 1 and 2) for a time duration (e.g., w_{A2}+IFS_{A2}) and transmit if provider A's primary and secondary channels (e.g., channels 1 and 2) are idle within the time duration. If provider B selects to attempt a dual band transmission, provider B may listen on provider B's primary and secondary channels (e.g., channels 3 and 2) for a time duration (e.g., w_{B2}+IFS_{B2}) and transmit if provider B's primary and secondary channels (e.g., channels 3 and 2) are idle within the time duration.

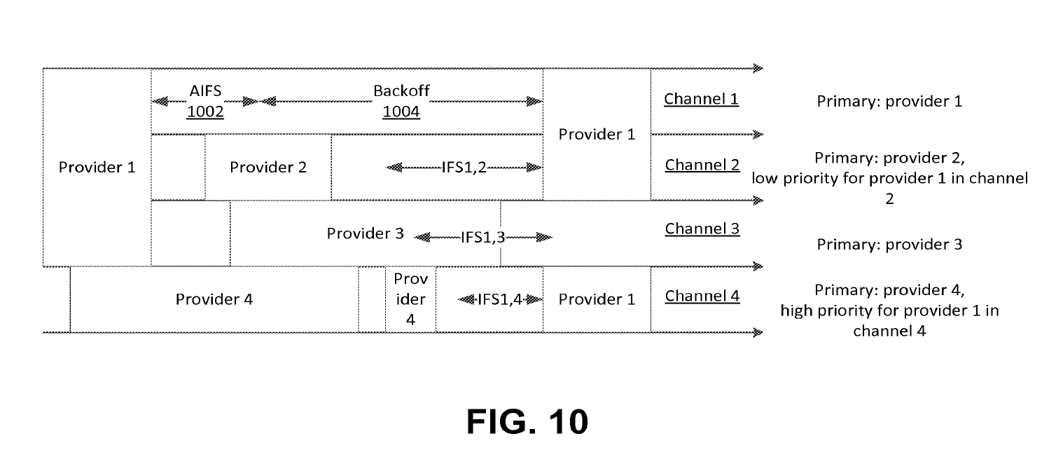

Priority-based secondary channel transmission may be performed with adjustable inter-frame spacing, backoff duration, and/or clear channel assessment (CCA) threshold for overlapping primary and secondary channels. The backoff procedure on the primary channel (e.g., channel 1) may involve the STA/AP (e.g., an STA or an AP associated with provider 1) checking for activity for a total duration of an Arbitration Inter-Frame Spacing (AIFS) duration (e.g., AIFS 1002 in FIG. 10) plus a backoff duration (e.g., Backoff 1004) that may depend on the contention window size for the node (e.g., AP or STA). The combination of the AIFS duration and the backoff duration may determine the priority with which the STA/AP may be able to acquire the medium. The priority of a transmission in a secondary channel (e.g., channel 2) may be modified to ensure that the primary provider of the secondary channel, e.g., the provider that has the channel as its primary channel (e.g., provider 2) may have a higher priority of transmission. When there are multiple secondary providers vying for channel access, the transmission priorities of the different secondary providers may be different. The interframe spacing between transmissions, the backoff duration, and/or the clear channel assessment threshold may be used to adjust the transmission priorities. Clear channel assessment may be based on the node evaluating the activity in the channel using the energy detected in the channel as a metric.

As shown in FIG. 7, the secondary channels (e.g., channels 720, 730 and/or 740) may be checked (e.g., by provider 1) for activity one PIFS before the intended transmit time. This may assign the same priority to the secondary provider in each of the secondary channels and may assign a slightly higher priority to the secondary provider over the primary provider as the spacing (e.g., PIFS) is less than the spacing for the primary provider (e.g., DIFS). A secondary channel may be checked for activity x IFS before the intended transmit time, where x may be variable and may depend on the level of aggressiveness desired in that secondary channel. Each secondary provider may have a different value of x in each channel. This may have the effect of modifying the access priority of the providers in the channels.

Prioritization by the sender (e.g. AP) may be performed (e.g., by one or more providers, by one or more APs associated with one or more providers, by a central controller, or by any network entity) by changing the backoff window. A modification of the priorities in the primary and secondary channels may be done by assigning separate backoff durations to the primary and secondary channels for a STA. The backoff durations may be estimated by, for example, using separate contention windows for each channel or using a contention window for the primary channel and having a fixed offset for the secondary channels. The offset may increase or decrease the backoff window with respect to the backoff window for the primary channel. This offset may increase the backoff in the secondary window to reduce the priority of the secondary provider.

Prioritization by the sender (e.g. AP) may be performed (e.g., by one or more providers, by one or more APs associated with one or more providers, by a central controller, or by any network entity) by changing the CCA thresholds of the secondary providers in the secondary channels. The CCA threshold may determine the aggressiveness of channel access. If the CCA threshold is high, the provider may be more aggressive in reserving access to the channel and may interfere more during the transmission. If the CCA threshold is low, the provider may be less aggressive and may interfere less. Setting the CCA threshold for the secondary provider lower than that of the primary provider in a channel may reduce the priority of transmission of the secondary provider in a secondary channel.

Any combination of the IFS, the backoff window, and/or the CCA threshold may be used for prioritization. Prioritization parameter(s) may include a combination of one or more of the IFS, the backoff window, or the CCA threshold used for prioritization. A channel allocation procedure may include one or more of the following. A provider may have a primary channel with one or more (e.g., three) secondary channels. The provider may negotiate with (e.g., all or some) other provider(s) in the band to estimate prioritization parameter(s) for its secondary channel(s). A node may comprise an AP and/or STA, which may be associated with a network. The negotiation may lead to a set of prioritization parameters. The provider may communicate the secondary parameter values to a node(s) (e.g., AP(s) or STA(s)) in the network. A node associated with a provider (e.g., node 1 of provider 1) may perform CSMA/CA backoff on its primary channel, for example if the node has determined to access its primary channel. The node may perform (e.g., simultaneously perform) CSMA/CA procedure (e.g., a modified CSMA/CA procedure) for at least one (e.g., all) of its secondary channel(s). The node may alter (e.g., cancel) transmission, for example when there is activity on the secondary channel(s). As the duration of the IFS period and/or the backoff duration on a secondary channel reduces, the probability that there is no activity on the channel may increase. The receiver may be (e.g., explicitly or implicitly) signaled of the (e.g., exact or approximate) transmission bandwidth used proximate to (e.g., at) the transmit time.

Table 1 illustrates an example channel allocation for a multi-provider network with four network providers and four frequency bands available. The providers may include, for example, hotspot providers or unmanaged and/or untethered AP/STAs. Each provider may have a primary channel with three secondary channels. The providers may use an inter-provider channel allocation procedure, for example to ensure that the primary channels do not substantially overlap (e.g., to ensure that the primary channels are orthogonal to each other).

TABLE 1
Channel Allocation

| | Channel 1 | Channel 2 | Channel 3 | Channel 4 |
|---|---|---|---|---|
| Provider 1 | Primary | Secondary | Secondary | Secondary |
| Provider 2 | Secondary | Primary | Secondary | Secondary |
| Provider 3 | Secondary | Secondary | Primary | Secondary |
| Provider 4 | Secondary | Secondary | Secondary | Primary |

A provider, (e.g., each provider) may negotiate with (e.g., all or some of) the other provider(s) in the band to estimate the prioritization parameter(s) for (e.g., all or some of) its secondary channel(s). For example, IFSx,y may indicate the inter-frame spacing for provider x in channel y. BKx,y may indicate the back-off window for provider x in channel y. CCAx,y may indicate the CCA threshold for provider x in channel y. The prioritization parameter(s) may be estimated. For example, the primary provider may broadcast the prioritization parameter(s) desired for secondary providers (e.g., all secondary providers), for example, in a selected frame in the beacon, based on its traffic load, traffic type, traffic delay, the number of secondary providers, and the like. A central entity may collate information and may estimate the prioritization parameter(s) for the secondary providers. A secondary provider may request for a specific prioritization parameter(s). The primary provider may assent to the request or may request for an increase or decrease in the prioritization parameter(s). A primary provider may request that secondary providers change the values of the parameter(s). The providers may have (e.g., at the end of the procedure) parameters for the secondary channels as shown in Tables 2, 3, and 4.

TABLE 2
InterFrame Spacing for Secondary Channels

| | Channel 1 | Channel 2 | Channel 3 | Channel 4 |
|---|---|---|---|---|
| Provider 1 | | IFS1,2 | IFS1,3 | IFS1,4 |
| Provider 2 | IFS2,1 | | IFS2,2 | IFS2,3 |
| Provider 3 | IFS3,1 | IFS3,2 | | IFS3,3 |
| Provider 4 | IFS4,1 | IFS4,2 | IFS4,3 | |

TABLE 3
BK Thresholds for Secondary Channels

| | Channel 1 | Channel 2 | Channel 3 | Channel 4 |
|---|---|---|---|---|
| Provider 1 | | BK1,2 | BK1,3 | BK1,4 |
| Provider 2 | BK2,1 | | BK2,2 | BK2,3 |
| Provider 3 | BK3,1 | BK3,2 | | BK3,3 |
| Provider 4 | BK4,1 | BK4,2 | BK,3 | |

TABLE 4
CCA Thresholds for Secondary Channels

| | Channel 1 | Channel 2 | Channel 3 | Channel 4 |
|---|---|---|---|---|
| Provider 1 | | CCA1,2 | CCA1,3 | CCA1,4 |
| Provider 2 | CCA2,1 | | CCA2,2 | CCA2,3 |
| Provider 3 | CCA3,1 | CCA3,2 | | CCA3,3 |
| Provider 4 | CCA4,1 | CCA4,2 | CCA,3 | |

The providers may communicate the secondary parameter values to the nodes (e.g., all the nodes) in their respective networks. This may be done by, for example, periodic announcements in the beacons and/or announcements by dedicated secondary parameter (e.g., IFS, CCA_threshold, backoff) announcement frames. These frames may include secondary channel indices and/or secondary channel inter-frame spacing durations. A node associated with a provider (e.g., node 1 of provider 1) may go through CSMA/CA backoff on its primary channel, for example when the node may determine to access the channel. It may listen to channel 1 for a duration of AIFS+backoff seconds. If there is no activity during this duration, node 1 may be cleared to transmit on channel 1. Activity may be determined by energy exceeding a CCA threshold for channel 1. For the primary channel, the threshold may be a CCA threshold specified by a standard. If there is activity on the primary channel during this period, node 1 may cancel the transmission. Upon cancelling the transmission, the node may resume the CSMA/CA. The transmission may be from another node in provider 1 or from a node belonging to a secondary provider.

A CSMA/CA may be performed, e.g., simultaneously for the secondary channels. At a time AIFS+backoff−IFS1,2 seconds, node 1 may listen to channel 2 for IFS1,2 seconds. If there is no activity during this period, node 1 may be cleared to transmit on channel 2. Activity may be determined by energy exceeding a CCA threshold for channel 2. For the secondary channel (e.g., channel 2), the threshold may be CCA1,2. At a time AIFS+backoff−IFS1,3 seconds, node 1 may listen to channel 3 for IFS1,3 seconds. If there is no activity during this period, node 1 may be cleared to transmit on channel 3. Activity may be determined by energy exceeding a CCA threshold for channel 3. For the secondary channel (e.g., channel 3), the threshold may be CCA1,3. At a time AIFS+backoff−IFS1,4 seconds, node 1 may listen to channel 4 for IFS1,4 seconds. If there is no activity during this period, node 1 may be cleared to transmit on channel 4. Activity may be determined by energy exceeding a CCA threshold for channel 4. For the secondary channel (e.g., channel 4), the threshold may be CCA1,4. If there is activity on the secondary channels (e.g., any of secondary channels), the node may cancel transmission on the secondary channel or may cancel all transmissions.

As the combined duration of the IFS period and backoff duration on a secondary channel decreases, the probability that there is no activity on the channel may increase, and the probability that the secondary provider may be able to reserve the channel may increase. This may have the effect of increasing the priority of the secondary user.

The receiver (e.g., STA) may be signaled with the transmission bandwidth (e.g., at the transmit time). For example, if PHY packet aggregation is used, a PPDU may be split between different channels. Data transmitted on different channels may be coded together as one block or may be coded separately in individual blocks that may correspond to a specific channel. A PLCP header on a channel (e.g., each channel) may have an indication that part of the PPDU may be transmitted on parallel channels and may have an indication of channel ID(s). The PLCP header may indicate the order in which data may be arranged to combine in a single PPDU. If the TXOP for the secondary channel is lost before the transmission time (e.g., after preparation of the packet), the STA may change the PLCP header before the actual transmission. If the data being sent on each channel are coded separately, it may facilitate the quick modification of the packet.

If MAC packet aggregation is used, PPDUs being sent on different channels may be coded separately. A PLCP header may have an indication that another PPDU from the same MPDU may be transmitted on a parallel channel or channels and may have an indication of a channel ID or channel IDs. The PLCP header may also indicate an order in which PPDUs may be arranged to create an MPDU.

Indication of transmission bandwidth may be performed explicitly or implicitly. For example, a new bandwidth indicator field may be included in the SIG field in a PLCP header transmitted in the primary channel. The field may indicate the IDs of the other channels that may be used in parallel with the primary channel. The field may comprise a bitmap of the channels used in parallel. The transmitted bandwidth may also be implicitly indicated, for example, by masking the Cyclic Redundancy Check (CRC) of a SIG field with a bitmap of the channels used for simultaneous transmission. The CRC of a SIG field on a channel (e.g., each channel) may be masked PAID of the STA to which the data is transmitted.

If the number of channels available for transmission is known before transmission, there may be a time constraint for encoding the transmitted data. To ensure that the transmitter has enough time to encode the data to be transmitted on the available channels, the data may be encoded for the maximum number of channels and may be encoded for each channel separately. At transmission time, the encoder may send the data for the available channels. The data may be encoded for multiple (e.g., all) possible transmit channel combinations, e.g., for a two-channel network, the transmitted signal may be encoded assuming transmission on channel 1, then again encoded assuming transmission on channel 2, and then again encoded assuming transmission on both channels 1 and 2. At transmission time, the encoder may send the data for the available channels.

FIG. 10 illustrates an example transmission for provider 1. In this example, its priority may change (e.g., increase or decrease) from channel 2, to channel 3, and then to channel 4. Priority may be inversely proportional to the inter-frame spacing in this example. For example, the priority of provider 1 in channel 4 may be higher than its priority in channel 2 because IFS1,4 is shorter than IFS1,2. Based on the data transmitted by the primary providers in channels 2, 3, and 4, provider 1 may be able to transmit in channels 1, 2, and 4.

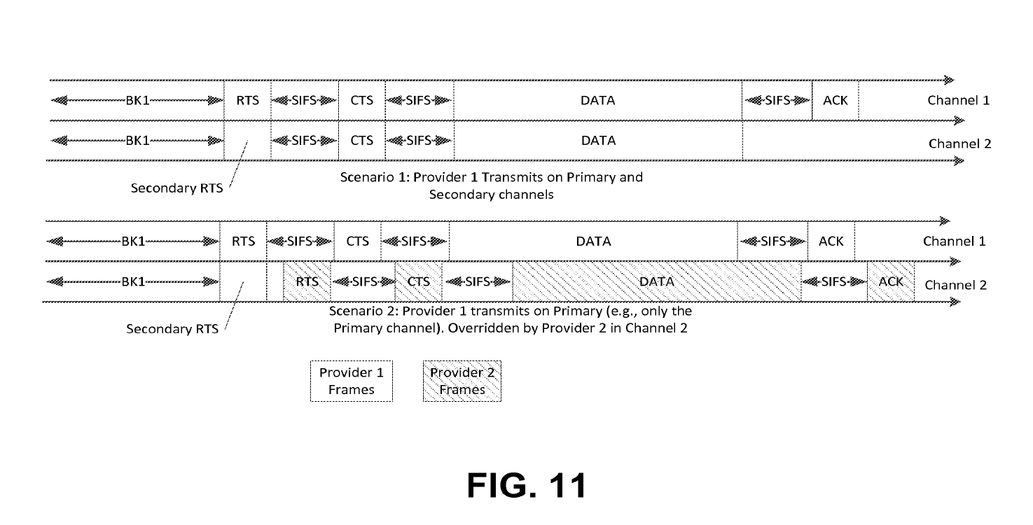

Priority-based transmission may be performed on the secondary channel using a secondary RTS/CTS reservation mechanism for overlapping primary and secondary channels. FIG. 11 illustrates an example of secondary RTS/CTS transmission in a multi-provider network. The node requesting transmission may use explicit frames to set the network allocation vector (NAV), e.g., to avoid hidden nodes. The explicit frames used may include an RTS/CTS frame exchange on the primary channel and a secondary RTS/secondary CTS frame exchange on the secondary channel. This secondary reservation may be overridden by a node that uses that channel as a primary channel, e.g., as illustrated in Scenario 2 of FIG. 11. This may give the primary provider higher priority on this channel.

In an example, two providers AP1 and AP2 may exist in a multi-provider network. AP1 and its associated STAs may be on primary channel 1 and secondary channel 2, and AP2 and its associated STAs may be on primary channel 2 and secondary channel 1. One or more of the following may apply.

AP1 may have a total combined AIFS and backoff time of BK1 for traffic to be sent to STA1. At a time BK1, AP1 may detect no activity on channel 1 and may send out an RTS on channel 1 to STA1. At a time BK1+SIFS, STA1 may send a CTS to AP1 indicating that the channel is clear and that data may be transmitted from AP1 to STA1 for the duration of the transmit opportunity. Other APs and STAs in the network may set their NAV for the duration of the transmission. At a time BK1, AP1 may detect no activity on channel 2 and may send out a secondary RTS on channel 2 to STA1.

AP1 may successfully reserve the secondary channel, e.g., channel 2. One or more of the following may occur when AP1 reserves the secondary channel. At a time BK1+SIFS, STA1 may send a CTS to AP1 that may indicate that the channel is clear and that data may be transmitted from AP1 to STA1 for the duration of the transmit opportunity. Other APs and STAs may set their NAVs for the duration of the transmission. AP1 may transmit on both channels successfully.

AP1 may be unable to successfully reserve the secondary channel, e.g., channel 2. One or more of the following may occur when AP1 does not reserve the secondary channel. At a time t such that BK1+length(RTS)<t<BK1+length(RTS)+SIFS (e.g., between the transmission of the secondary RTS and the CTS from STA1), a node in provider 2 (e.g., AP2 or its associated STAs) may send out an RTS to reserve the medium. This may have the effect of overriding the secondary RTS sent by provider 1 on its secondary channel. APs and STAs may reset their NAV to the duration requested by AP1.

Different backoff durations may be used on the primary and secondary channels, e.g., to emphasize the priority of the primary provider on its primary channel. The backoff of a provider may be larger on its secondary channel than on its primary channel.

Using different back-off durations may include one or more of the following. An AP may send (e.g., at time BK1) a RTS on the primary channel (e.g., channel 1) to a STA, e.g., when no activity is detected on the primary channel. The STA may send (e.g., at time BK1+SIFS) a CTS to the AP, e.g., to indicate that the primary channel is clear to send data on. The AP may send (e.g., at time BK2) a secondary RTS on the secondary channel (e.g., channel 2) to the STA, e.g., when no activity is detected on the secondary channel. The AP may receive (e.g., at time BK1+SIFS) a secondary CTS from the STA, e.g., to indicate that the secondary channel is clear to send data on. The secondary RTS may be overridden by a RTS sent by another node that uses channel 2 as its primary channel.

Use of different back-off durations may include one or more of the following.

AP1 may have a total AIFS+backoff time of BK1 for traffic to be sent to STA1. At a time BK1, AP1 may detect no activity on channel 1 and may send an RTS on channel 1 to STA1. At a time BK1+SIFS, STA1 may send a CTS to AP1 that may indicate that the channel is clear and that data may be transmitted from AP1 to STA1 for the duration of the transmit opportunity. Other APs and STAs (e.g., all other APs and STAs) in the network may set their NAV for the duration of the transmission.

At a time BK2 (where BK2 may be less than BK1), AP1 may detect no activity on channel 2 and may send a secondary RTS on channel 2 to STA1. The secondary RTS may include an additional field (e.g., that may include BK1), for example to enable STA1 to estimate the secondary IFS or the inter-frame spacing to enable transmission of the CTS at the same time. The secondary IFS may be implicitly estimated from the RTS/CTS exchange in the primary channel.

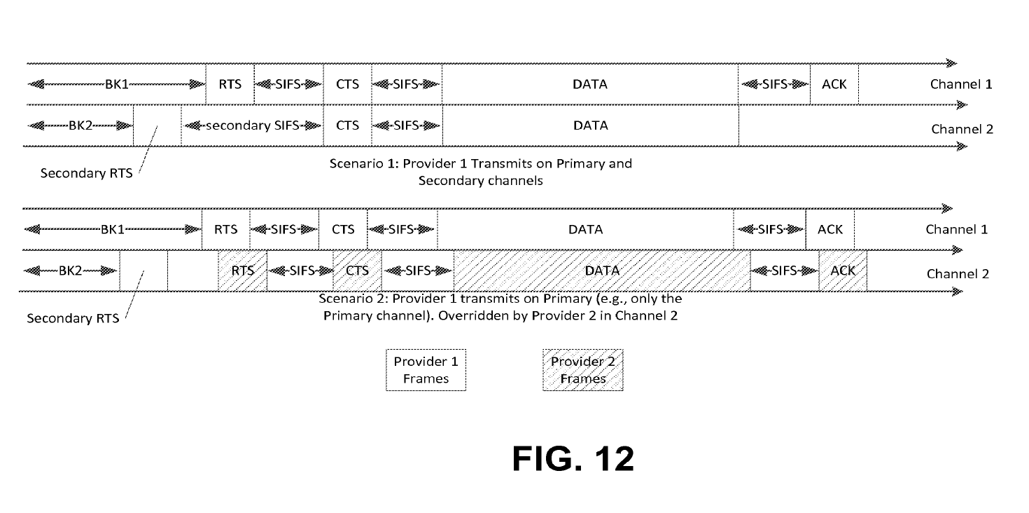

FIG. 12 illustrates an example of secondary RTS/CTS transmission with backoff-based prioritization. If AP1 successfully reserves the secondary channel (e.g., channel 2), for example as shown in scenario 1 in FIG. 12, at a time BK1+SIFS, STA1 may send a CTS to AP1 that may indicate that the channel is clear and that data may be transmitted from AP1 to STA1 for the duration of the transmit opportunity. Other APs and STAs (e.g., all other APs and STAs) may set their NAVs for the duration of the transmission. AP1 may transmit on both channels (e.g., channels 1 and 2) successfully.

If AP1 is unable to successfully reserve the secondary channel (e.g., channel 2), for example as shown in scenario 1 in FIG. 12, at a time t, e.g., such that BK2+length(secondary RTS)<t<BK2+length(secondary RTS)+secondary IFS (between the transmission of the secondary RTS and the CTS from STA1), a node in provider 2 (e.g., AP2 and its associated STAs) may send an RTS to reserve the medium. This may have the effect of overriding the secondary RTS sent by provider 1 on its secondary channel.

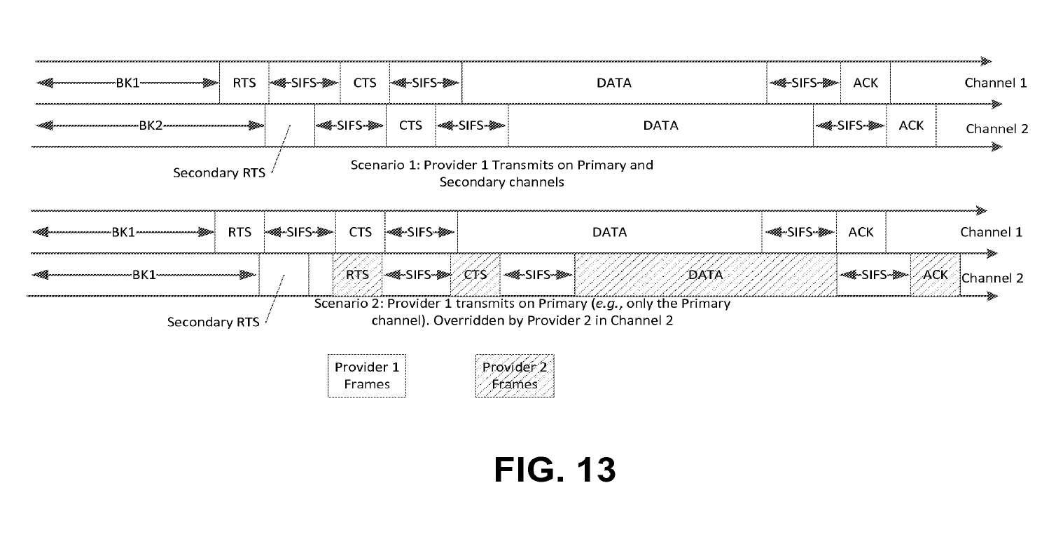

When there are independent MACs and radios for each band, the backoff of the secondary channel (e.g., BK2) may be set larger than that of the primary channel (e.g., BK1) and larger than that of AP2 in channel 2 (e.g., the primary provider of the channel), as illustrated in FIG. 13.

The inter-frame spacing between frame transmissions for providers may be modified, e.g., to emphasize the priority of the primary provider (e.g., a node of the primary provider, for example AP1) on its primary channel. For example, each provider, x, may establish an inter-frame spacing (e.g., a minimum inter-frame spacing minIFS,x). For specific frame sequences, a secondary provider sending data in its channel may use this spacing. Examples of frame transitions may include one or more of the following. A secondary RTS to CTS transition that may give the primary provider of the channel the time to override the secondary RTS request. An ACK to data transmission transition. In a TxOP, such a transition may give the primary provider of the channel the time to override a long TxOP requested by a secondary provider (e.g., AP2).

Modification of the inter-frame spacing may include one or more of the following. A provider x may send an IFS, e.g., a minimum IFS, for specific frame sequences as minIFS,x. This may be sent in a (e.g., dedicated) frame or may be sent by the beacon. AP1 may have a total AIFS+backoff time of BK1 for traffic to be sent to STA1. At a time BK1, AP1 may detect no activity on channel 1 and may send an RTS on channel 1 to STA1. At a time BK1+SIFS, STA1 may send a CTS to AP1 that may indicate that the channel is clear and that data may be transmitted from AP1 to STA1 for the duration of the transmit opportunity. Other (e.g., all other) APs and STAs in the network may set their NAVs for the duration of the transmission. At a time BK1+length (RTS)+SIFS−minSIFS,2−length(modified RTS), AP1 may detect no activity on channel 2 and may send a secondary RTS on channel 2 to STA1.

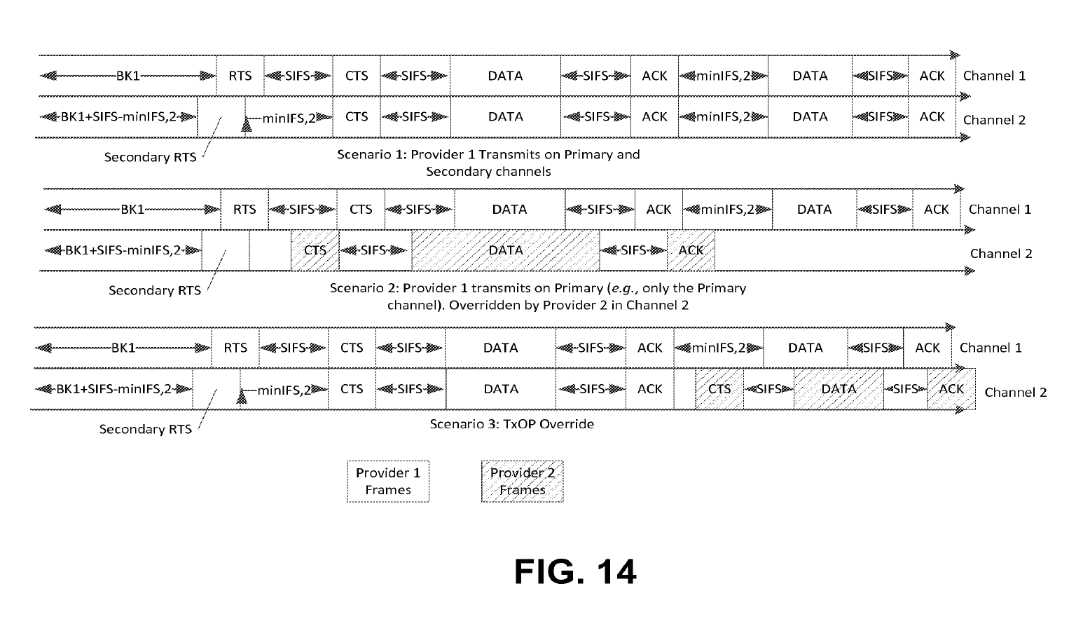

FIG. 14 illustrates an example of secondary RTS/CTS with inter-frame spacing-based prioritization. If AP1 successfully reserves the secondary channel (e.g., channel 2) for the entire TxOP duration, for example as shown in scenario 1 in FIG. 14, at a time BK1+SIFS, STA1 may send a CTS to AP1 that may indicate that the channel is clear and that data may be transmitted from AP1 to STA1 for the duration of the transmit opportunity. Other APs and STAs (e.g., all other APs and STAs) may set their NAVs for the duration of the transmission. AP1 may transmit on both channels (e.g., channels 1 and 2) successfully.

If AP1 is unable to reserve the secondary channel (e.g., channel 2), for example as shown in scenario 2 in FIG. 14, at any time t between the transmission of the secondary RTS and the CTS from STA1, any node in provider 2 (e.g., AP2 and its associated STAs) may send an RTS to reserve the medium. This may have the effect of overriding the secondary RTS sent by provider 1 on its secondary channel (e.g., channel 2).

The AP1 may successfully reserve the secondary channel (e.g., channel 2), but may be unable to reserve the secondary channel for the entire TxOP duration (e.g., as illustrated in Scenario 3 in FIG. 14). In the case of a transmit opportunity (TxOP) with multiple data-ACK transmissions and successful transmission on both primary and secondary channels, the inter-frame spacing between the data and ACK frames may be kept as SIFS, but the inter-frame spacing between an ACK frame and a new data frame may be set to minIFS,2. If provider 2 does not have any data to send, transmission between AP1 and STA1 may continue. If provider 2 does have data to send, provider 2 may send a RTS on channel 2 in the duration between the ACK and the new data frame. The NAVs of the nodes on channel 2 may be reset. The inter-frame spacing for the transmission between AP1 and STA1 may revert back to SIFS.

Secondary RTS/CTS with inter-frame spacing-based prioritization may be used for single packet transmission or for transmission of multiple packets within a transmit opportunity (TxOP). It may be extended to any TxOP reservation procedure. Any TxOP reservation frame may be extended to a primary and secondary TxOP reservation frame. The priority of a provider may be determined by the backoff duration and/or the inter-frame spacing.

Priority-based secondary channel transmission may be performed with adjustable inter-frame spacing, backoff duration, and/or CCA threshold for similar (e.g., identical) primary and secondary channels. The providers may have similar (e.g., identical) primary channels and similar (e.g., identical) secondary channels, e.g., as shown in FIG. 6. Some of the providers may determine, for example, based on the interference in the system (e.g., on the primary channel) to send information on the secondary channel or channels (e.g., only on the secondary channel or channels). This may be due to crowding in the primary channel. CSMA/CA clear channel assessment techniques may enable this functionality.

Priority based secondary channel transmission may include one or more of the following. A two-provider system may transmit in a network with two channels, e.g., channel 1 and channel 2. Channel 1 may serve as the primary channel for both providers (e.g., providers 1 and 2), while channel 2 may serve as the secondary channel for both providers. Providers 1 and 2 may coordinate between themselves and may allocate a higher priority to provider 2 on the secondary channel. In this configuration, provider 2 may determine to limit its transmission to channel 2 (e.g., to channel 2 only). Provider 2 may perform CSMA/CA channel access on channel 2 (e.g., on channel 2 only) with the prioritization parameter(s) set, e.g., to ensure that it accesses the channel with higher priority. The priority of provider 2 may be set by using the Adjustable Inter-Frame Spacing (AIFS), Backoff Duration, and/or CCA Threshold as disclosed herein. Provider 1 may perform CSMA/CA channel access on channel 1 with secondary access to channel 2 when channel 2 is not in use.

Priority-based transmission may be performed on the secondary channel using secondary RTS/CTS reservation for identical (e.g., substantially identical) primary and secondary channels. The providers may have identical primary channels and identical secondary channels. Some of the providers may determine, for example, based on interference in the system (e.g., on their primary channel) to send information on the secondary channel or channels (e.g., only on the secondary channel or channels). This may be due to crowding on the primary channel. A secondary RTS/CTS mechanism may enable this functionality.

Priority based transmission on the secondary channel may include one or more of the following. A multi-provider system may transmit in a network with two channels, e.g., channel 1 and channel 2. Channel 1 may serve as the primary channel for the providers (e.g., providers 1 and 2), while channel 2 may serve as the secondary channel for the providers. The primary channel may be accessed by CSMA/CA. A secondary RTS/CTS frame sequence transmitted on the primary channel may request access on the secondary channel for a desired duration.

Provider 1 may send a secondary RTS on channel 1 requesting for 20 MHz transmission on channel 2. Provider 1 may receive a CTS on the secondary channel clearing it to transmit on the secondary channel (e.g., only on the secondary channel). Provider 1 may receive a CTS on the primary channel clearing it to transmit on the secondary channel (e.g., only on the secondary channel).

In a code domain, interference may be reduced or minimized with unmanaged devices or independent providers. The code domain examples disclosed herein may be applied to different BSSs from the same provider, e.g., to reduce OBSS.

Interference may be mitigated in a WiFi system from unmanaged devices or multiple independent providers. Interference mitigation scrambling operations may be introduced in a WiFi system by applying different scrambling sequences to different transmitters. An interference mitigation scrambler may be applied (e.g., immediately) after channel coding. The scrambled signal may be descrambled at the receiver, e.g., to randomize interference from different transmitters and mitigate the interference. A legacy WiFi scrambler may be located before a channel coding block and may remove long strings of 1s or 0s, e.g., to make clock recovery easier. An interference mitigation scrambler may be added, e.g., to reduce the effect of interference. An interference mitigation scrambler may ensure that the transmitted signal is multiplied (e.g., an exclusive OR operation) by an interference mitigation scrambling sequence or code, e.g., to reduce the effect of interference from other providers or from other BSSs transmitted by the same provider. By applying different scrambling sequences for different transmitters, interfering signals from other transmitters after descrambling may be randomized and mitigated. Multi-provider interference mitigation, inter-BSS interference mitigation, and/or concurrent transmission may be realized, e.g., by applying different interference mitigation scrambling sequences to different APs.

Interference mitigation scrambling for a WiFi system may be disclosed herein. Generation and allocation of scrambling sequences used in the interference mitigation scrambling operation for a WiFi system may be disclosed herein. Signaling of information related to the interference mitigation scrambling operation may be disclosed herein.

Interference mitigation scrambling for a WiFi system may be implemented using a scrambler or a combination of scramblers disclosed herein. An interference mitigation scrambling operation may be performed by bit-level interference mitigation scrambling or complex symbol-level interference mitigation scrambling. Bit-level interference mitigation scrambling may provide lower implementation complexity than complex symbol-level scrambling.

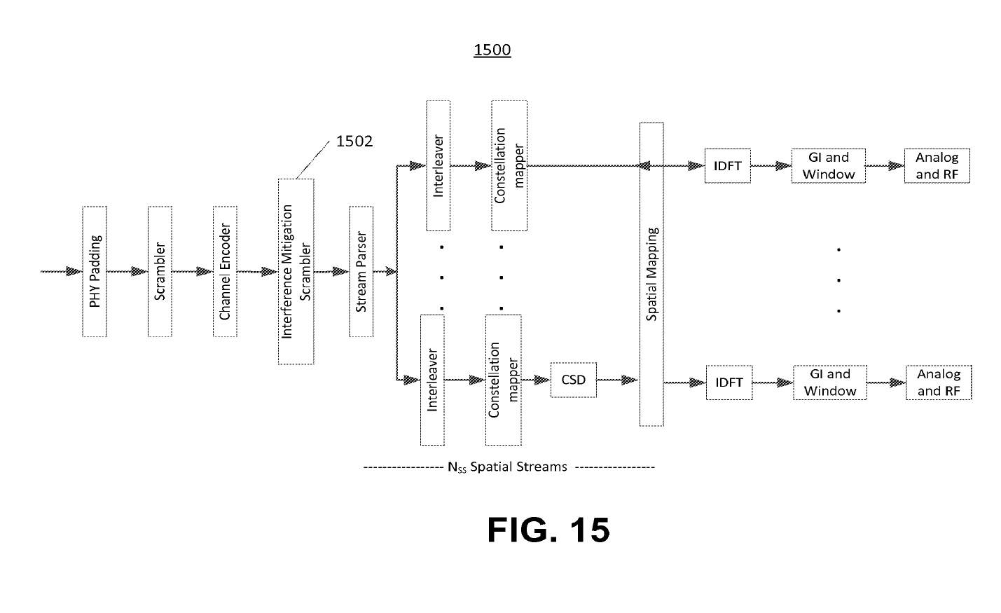

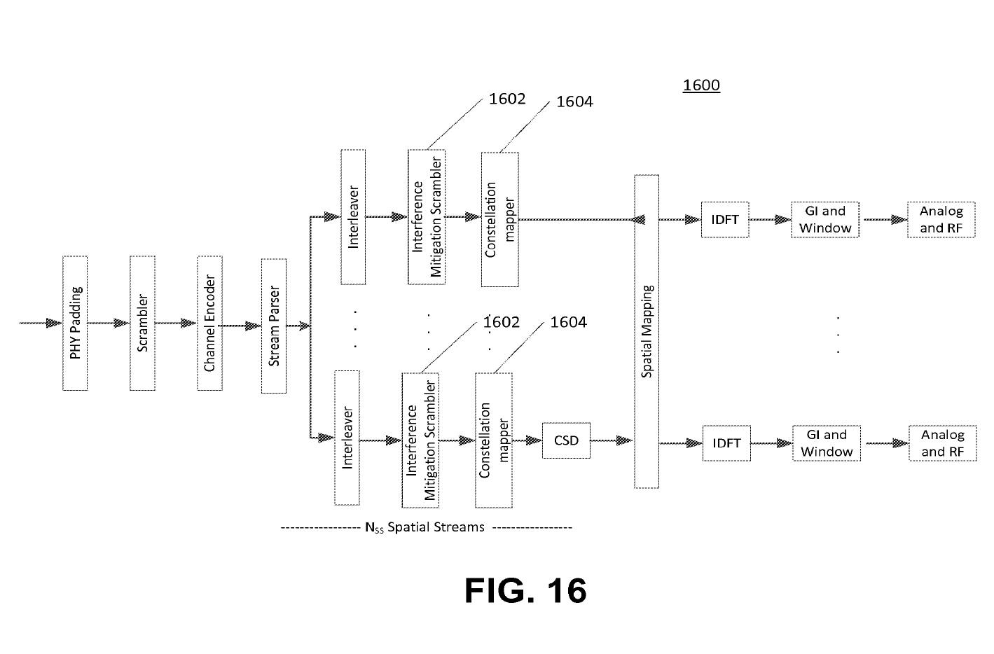

A bit-level interference mitigation scrambler may be applied at bit-level per: codeword and/or stream. The bit-level interference mitigation scrambler (e.g., an interference mitigation scrambling operation) may be applied at a bit level on a codeword basis. For example, in an example transmitter 1500, an interference mitigation scrambler 1502 may be introduced after the channel encoder (e.g., FEC encoder, BCC encoder, or LDPC encoder) and before a stream parser, as shown in FIG. 15. The coded blocks corresponding to a codeword may be concatenated and scrambled, e.g., if multiple BCC encoders are used to generate multi-coded blocks. The interference mitigation scrambler operation may be applied at a bit level per stream. For example, in an example transmitter 1600, an interference mitigation scrambler 1602 may be introduced before a constellation mapper 1604, as shown in FIG. 16.

A symbol-level interference mitigation scrambler (e.g., an interference mitigation scrambling operation) may be applied at a complex symbol level. Symbol-level interference mitigation may include one or more of the following. The interference mitigation scrambler operation may be applied at a modulation symbol level, e.g., the interference mitigation scrambler may be introduced (e.g., immediately) after a constellation mapper. The interference mitigation scrambler operation may be applied at an OFDM symbol level, e.g., the interference mitigation scrambler may be introduced before IDFT (or IFFT). The scrambling may be applied to all data subcarriers or to some data subcarriers (e.g., scrambling may be applied every N subcarriers, where N may be chosen for flat frequency selectivity). The interference mitigation scrambler operation may be applied at an OFDM symbol level in the time domain, e.g., the interference mitigation scrambler may be introduced after IDFT (or IFFT).

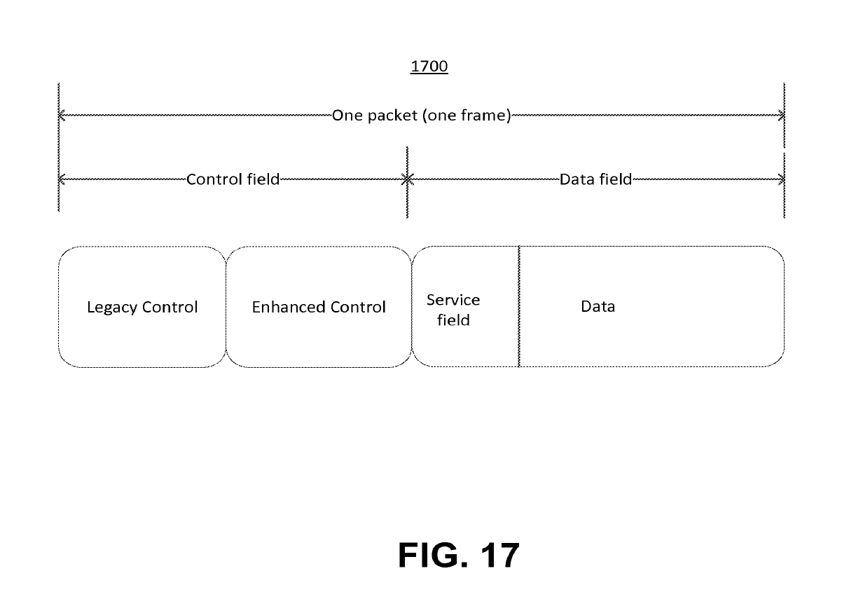

An operation mode may indicate an operation field, e.g., operation field 1700, to which interference mitigation may apply, for example as shown in FIG. 17. An operation mode may indicate that interference mitigation may apply to one or more of the following: no field of the packet, the entire packet or frame, the data field of the packet or frame (e.g., only the data field of the packet or frame), or to the data field and part of the control field of the frame. An example of four operation modes may include one or more of the following.

In a first operation mode (e.g., operation mode 0), an interference mitigation scrambling operation may not apply to fields of a packet, e.g., interference mitigation scrambling is not enabled, and, operation may fall back to the legacy WiFi system.

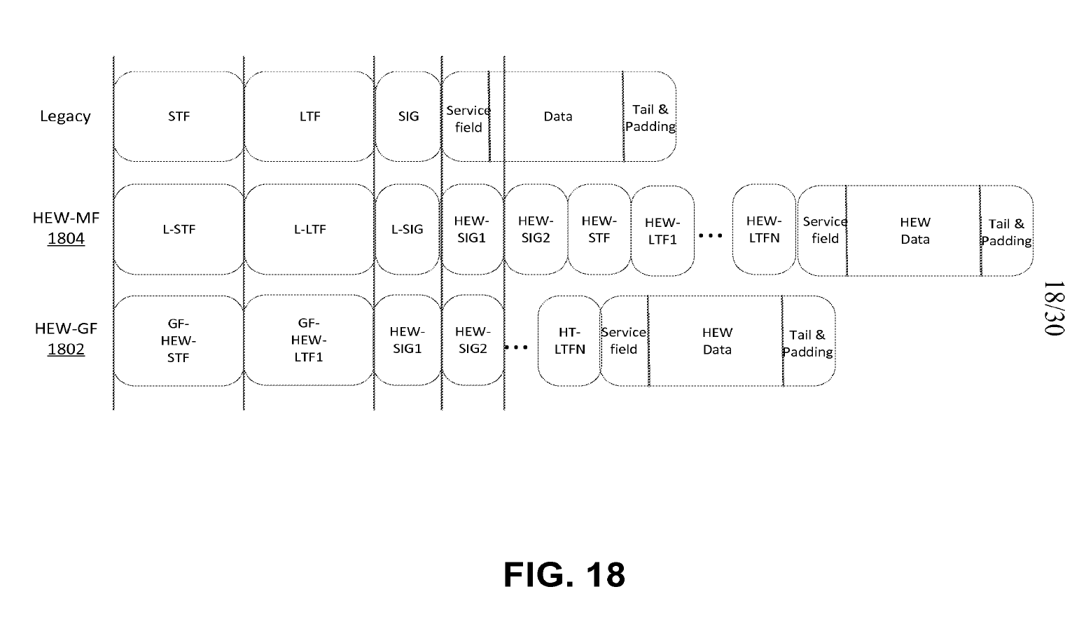

In a second operation mode (e.g., operation mode 1), an interference mitigation scrambling operation may be applied to the whole packet or the whole frame, which may include control and data fields. Operation mode 1 may be implemented with a HE WLAN Greenfield format (HE WLAN-GF) packet structure 1802, as shown in FIG. 18. This operation mode may be suitable for HE WLAN BSSs, e.g., where there may be no backward compatibility required or no co-existence problem. The interference scrambling operation related information may be signaled by a Capability information element or scrambling element, e.g., as disclosed herein.

In case of unplanned WLAN where legacy stations may exist, the legacy stations may not understand or receive the interference mitigation scrambling operation related information such as scrambling sequence, and may not detect the preamble to read the backoff time due to the potential corrupted cross-correlation of preamble from the interference scrambling sequence. A delayed auto-correlation may be used to fix this problem of packet (and/or backoff information) detection at the legacy STA without knowing the scrambling sequence. Due to the repetitive nature of the STF (e.g., 10 short training symbols in STF) and LTF (e.g., 2 long training symbols in LTF), an interference mitigation scrambling sequence may use the same length of multiple training symbols depending on auto-correlation length. For example, each STF short symbol may include 16 samples. A scrambling may be applied with the length of (K*16), where K is an auto-correlation length constrained to 1≦K≦5.

In a third operation mode (e.g., operation mode 2), an interference mitigation scrambling operation may be limited to apply to the data field, e.g., not to the control field.

In a fourth operation mode (e.g., operation mode 3), an interference mitigation scrambling operation may apply to the data field and to part of control field, such as Enhanced Control, which may be HT Preamble, VHT Preamble, and/or any Enhanced Preamble (e.g., HE WLAN Preamble) that may support the interference mitigation scrambling operation.

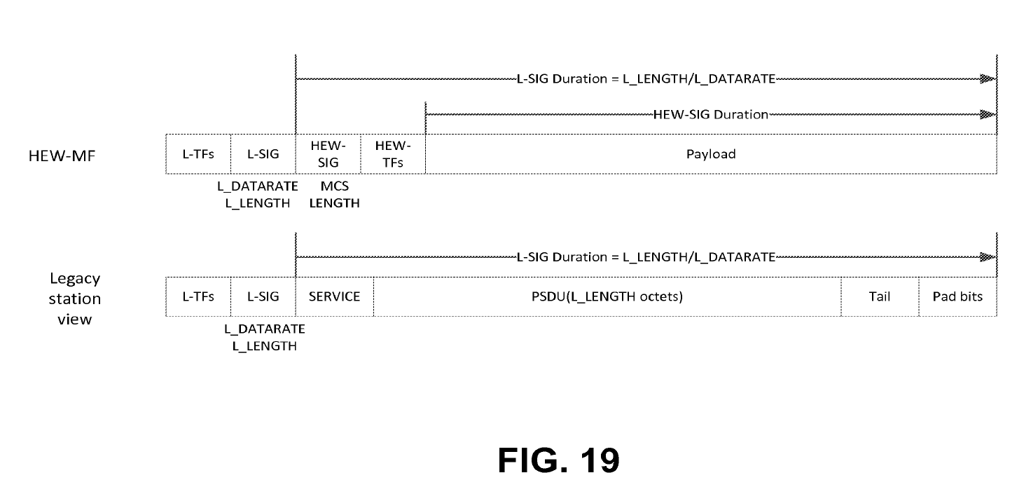

Operation modes 2 and 3 may be implemented with a HE WLAN mixed format (e.g., HE WLAN-MF) packet structure 1804, as shown in FIG. 18. To maintain backward compatibility, the HE WLAN-MF packet structure 1804 may keep legacy STF (L-STF), LTF (L-LTF) and SIG (L-SIG) before the scrambled packet. This may be data field (e.g., data field only) by operation mode 2. This may be data field and Enhanced control by operation mode 3. If the following scrambled packet is sent to the HE WLAN station with an interference mitigation scrambling operation, the legacy station may obtain the backoff information by using L-SIG Duration=L_LENGTH/L_DATARATE as shown in FIG. 19 to backoff, while HE WLAN-MF STA may descramble the scrambled data based on the received scrambling sequence information, e.g., by signaling methods disclosed herein.

Enabling an interference mitigation scrambling operation in WiFi systems may depend on one or more of the following operations.

If neighboring or interfering APs operate on a different channel, support for an interference scrambling operation may be disabled. Otherwise, support for the interference scrambling operation may be enabled, e.g., if neighboring or interfering APs operate on overlapping (e.g., identical) channels. For example, a BSSID can switch channel bandwidth dynamically on a frame-by-frame basis as defined in the 802.11ac standard. Support of the interference scrambling operation for the secondary channel(s) may be switched dynamically, e.g., on a frame-by-frame basis. Support for the interference scrambling operation may be enabled on the primary channel, e.g., may always be enabled on the primary channel.

Support of the interference mitigation scrambling operation among a group of APs may be enabled. Interference scrambling operation may be applied to a group of APs with the same scheduled level, the same priority, or in the same multi-apartment building. For example, in a multi-apartment building, one of a set of scrambling sequences with the group may be assigned to the AP in each apartment. Once an AP is powered on, the interference scrambling operation may be applied to it to mitigate the interference from other APs in other apartments. Scrambling sequences may be statically allocated to the group of APs or dynamically allocated to each AP.

A CCA energy threshold may be modified (e.g., increased) to support the interference mitigation scrambling operation. In a multi-provider network, stations may be detected as high energy by energy detection due to interference from neighboring APs. The CCA energy threshold may be modified (e.g., increased) to allow the STA to descramble the interference received and meet the CCA signal threshold after descrambling, e.g., in order to reduce interference.

Interference mitigation scrambling sequences may be generated and/or allocated. A scrambling sequence may be an orthogonal sequence or PN sequence that provides a good correlation property for interference mitigation. The scrambling sequence may be dynamically generated or may be statically allocated or signaled as disclosed herein.

Interference mitigation scrambling sequences may be dynamically generated, for example, on a per packet or per frame basis. The initialization value of the scrambling sequence may be a function of one or more factors, including, for example, an AP identification, a STA identification, a codeword index, a stream index, and/or a channel index.

An AP identification may include a MAC address, a BSSID, an SSID, and/or an ESSID, for example, if the same scrambling sequence is used for the APs within an ESS. For example, in the case of multiple providers, a scrambling sequence may be generated or allocated based on a provider ID. In the case of neighboring BSS interference mitigation, the scrambling sequence may be generated or allocated based on each AP's BSSID. This may be beneficial to decode the signal for the different APs or providers by randomization of the interference A STA identification may include a STA MAC address and/or a STA ID.

A codeword index may be denoted as id_cw ε {0,1}, for example, if more than one codeword is transmitted in a WiFi system. For example, up to two codewords may be transmitted in HE WLAN and beyond. For single codeword transmission, id_cw may be set equal to zero so that it may not affect the initialization of the scrambling sequence for a legacy WiFi system.

A stream index may be denoted as id_ss ε{0,1, . . . , (Nss−1)}, where Nss may be a maximum number of spatial streams transmitted. In the case of a single stream, id_ss may be set equal to zero so that it may not affect the initialization of the scrambling sequence.

A channel index may be denoted as id_ch ε {0,1, . . . , Nₛ_{_}_{ch}} in the case of different scrambling sequences used for different channels, e.g., primary or secondary channels. N_{S}_{_}_{ch} may be a maximum number of secondary channels, and id_ch=0 may indicate the primary channel.

Interference mitigation scrambling sequences may be generated and/or allocated (e.g., statically) to different transmitters, e.g., to reduce signaling overhead. For example, for multiple providers, a total of N_{scr} scrambling codes, numbered 0 . . . (N_{scr}−1) may be generated. The scrambling codes may be divided into K groups. A code group (e.g., each code group) may include L scrambling codes, e.g., N_{scr}=(K*L). The group number may be signaled to the STA, which may determine the scrambling sequence used through at most L correlations with codes within the signaled code group. L may be selected to be small enough to save the STA's processing power.

Interference mitigation scrambling operations may be signaled. To implement interference mitigation scrambling operations in WiFi systems, the receiver may know which scrambling operation is applied and/or how it is applied at the transmitter so that the receiver can apply the corresponding descrambling. Related information may be signaled. For example, the transmitter may signal whether the interference mitigation scrambling operation is supported or not. The transmitter may signal which interference mitigation scrambling code is used. The transmitter may signal which interference mitigation operation mode is applied, e.g., if the operation mode is not predefined in a specification or implicitly signaled. This information may be broadcast in a beacon, short beacon, or other types of management, control, or extension frames, which may be implemented as a field or subfield or subsets of subfields of an information element (IE), or as a part of a control or management frame or in a MAC or PLCP header.

Interference mitigation scrambling may be signaled by one or more of the following: an existing PLCP and/or MAC layer header, a new field or bit in the PLCP and/or MAC header, or an IE.

The interference mitigation scrambling operation may be signaled by a PLCP and/or MAC layer header (e.g., an existing PLCP and/or MAC layer header). In case of unmanaged devices, unplanned WiFi may have several generations of APs in the neighborhood. To keep backward compatibility, a frame format used by predecessors may be used. A reserved bit or bits or a reserved field or fields may be reused to signal the interference mitigation scrambling operation related information.

For example, the reserved bit (e.g., 1 bit) after Rate in a PLCP header may be used to indicate whether a transmitter supports the interference mitigation scrambling operation. If the reserved bit has a value of 1, then the transmitter may support the interference mitigation scrambling operation, and the receiver may perform the corresponding descrambling operation. If the reserved bit has a value of 0, then the transmitter may not support it, and the receiver may omit the interference mitigation descrambling.

Some or all of the reserved bits in a Service field (e.g., bits 7 to 15) may be used to signal which scrambling code is used at transmitter, for example, the index of scrambling code, or the initial state of scrambling code, or other information that the receiver can determinate which scrambling code is used at transmitter based on a predefined rule (e.g., the rule used to dynamically generate the interference mitigation scrambling code disclosed herein). The receiver may read, interpret, or derive the interference mitigation scrambling code to descramble the data stream.

A field or bit (e.g., new field or bit) may be introduced in a PLCP or MAC header, for example, to signal interference mitigation scrambling operation related information, such as operation mode, support of an interference mitigation scrambling operation, an operation mode as defined herein, a scrambling sequence or code that was used, and the like. A scrambling indicator field may be included in a SIG field of a PLCP header. The field may be a bitmap of the index of the scrambling code used for the data field.

An information element (IE) may be used to signal the interference mitigation scrambling operation. The interference scrambling element may be an IE or fields or subfields of an IE, which may be implemented as an element, subelement, or any management, control, or extension frames.

An element may signal interference mitigation scrambling operation related information, for example, using one or more fields or subfields of a Capabilities information element (IE) or by using a scrambling information element to include interference mitigation scrambling operation related information. An element may be present in the Beacon, Association Request, Association Response, Reassociation Request, Reassociation Response, Probe Request and/or Probe Response frames.

For example, as shown in Table 5, an HT Capabilities IE may include a field B16 to create a scrambled-HT (S-HT) Capabilities element.

TABLE 5
S-HT Capability Information Field for interference
mitigation scrambler

| Bits | Subfield | Definition | Encoding |
|---|---|---|---|
| B16 | Interference | Indicates support for | 0 = Not supported |
| | Mitigation | the interference | 1 = Supported |
| | Scrambling | mitigation scrambling | |
| | | operation | |

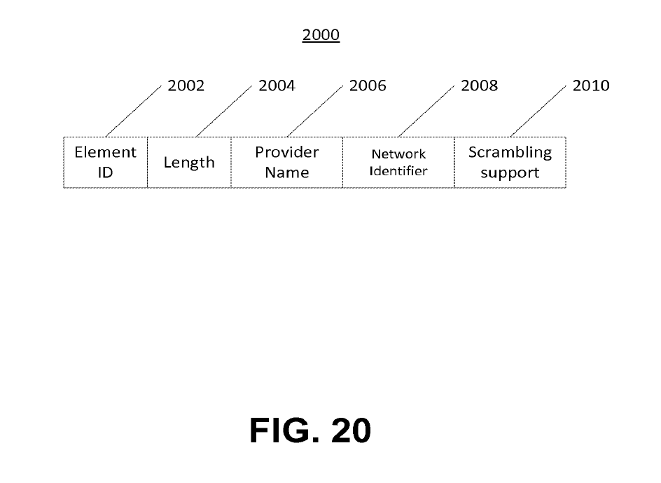

FIG. 20 illustrates an example interference mitigation scrambling information element (IE) 2000. The IE 2000 may include an element ID field 2002, a length field 2004, a provider name field 2006, a network identifier field 2008, and/or a scrambling support indicator field 2010.

The Element ID field 2002 may include an ID that may identify that the element includes an interference mitigation scrambling element. The length field 2004 may indicate the length of the interference mitigation scrambling element. The provider name field 2006 may indicate the name of the provider to which the scrambled AP belongs. The network identifier field 2008 may indicate any of a BSSID, an SSID, and/or an ESSID associated with the scrambled AP. The scrambling support indicator field 2010 may indicate support for the interference mitigation scrambling operation. The scrambling support indicator field 2010 may include a scrambling code subfield and/or a scrambling operation mode subfield, for example, if they may not be signaled by the PLCP or MAC header. The scrambling code subfield may indicate which scrambling code is used. The scrambling operation mode subfield may indicate which interference mitigation scrambling operation mode may be used, e.g., in case the interference mitigation scrambling operation field may be configurable but may not be predefined.

The reserved field of an IE may be reused or reinterpreted. For example, a B12 field may be reserved for an HT Capabilities IE. The B12 field may be reused or reinterpreted to signal the interference mitigation scrambling capability. For example, as shown in Table 6, a reserved value may be used to indicate that the interference mitigation scrambling operation is supported or unsupported. If B12 has a value of 1, for example, support for the interference mitigation scrambling operation may be indicated. A value of 0 in the B12 field may indicate that the interference mitigation scrambling operation is not supported.

TABLE 6
HT Capability Information Field for interference
mitigation scrambling

| Bits | Subfield | Definition | Encoding |
|---|---|---|---|
| B12 | Interference | Indicates support for | 0 = Not supported |
| | Mitigation | the interference | 1 = Supported |
| | Scrambling | mitigation scrambling | |
| | | operation | |

The phase of the interference mitigation scrambling sequence may be rotated by an angle, e.g., 90 degrees, at a predetermined point to signal a desired behavior or state, e.g., to enable the receiver to identify HE WLAN transmissions and/or improve detection between HE WLAN and non-HE WLAN transmissions or to enable a STA to identify a transmission from another node with the same scrambling sequence.

Providers may coordinate with other providers, e.g., to provide a sufficient level of services to their STAs. Providers may coordinate on parameters, such as, for example, the number of allowed associated STAs per AP, levels of services, primary and secondary channel prioritization parameters (e.g., xIFS, contention window sizes or backoff window sizes, and/or CCA thresholds), and/or interference scrambling parameters.

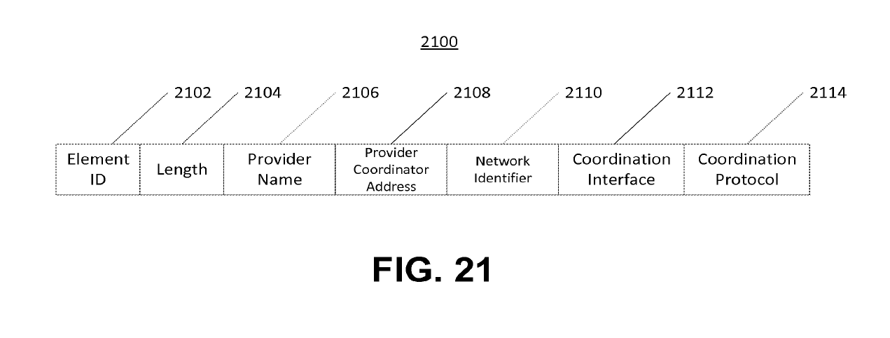

FIG. 21 illustrates an example Provider Coordinator information element (IE) 2100. An AP may announce its Provider Coordinator by including a Provider Coordinator IE 2100 in its beacon, short beacon, or any other type of management, control or extension frames. The Provider Coordinator IE 2100 may include an element ID field 2102, a length field 2104, a provider name field 2106, a provider coordinator address field 2108, a network identifier field 2110, a coordinator interface field 2112, and/or a coordination protocol field 2114.

The element ID field 2102 may include an ID that may identify that the IE is a Provider Coordinator IE. The length field 2104 may indicate the length of the Provider Coordinator IE. The provider name field 2106 may indicate the name of the provider, which may be a WLAN service provider, a cellular provider, a service consortium, etc. The provider name field 2106 may be implemented using strings or using a predetermined code that may be associated with one or more providers.

The provider coordinator address field 2108 may indicate the ID or address of the coordinator responsible for the coordination activity for the provider. The provider coordinator address field 2108 may include a type of address subfield that may indicate the type of address indicated, such as MAC address, IPv4 address, IPv6 address, etc. This subfield may be omitted, e.g., if the type of address is predetermined The provider coordinator address field 2108 may include an address subfield that may include the actual address of the provider coordinator, such as a MAC address, IPv4 address, IPv6 address, etc.

The network identifier field 2110 may indicate the identifier of the network of which the AP is a part. The network identifier field 2110 may be indicated using one or more of BSSID, SSID, eNB-ID, identifier of a routing or location area, or a tracking area.

The coordinator interface field 2112 may indicate the type of interface that the Provider Coordinator may use for coordination activities. Potential values may include, for example, WLAN (e.g., 802.11ac, 802.11ax, HE WLAN, etc.), Ethernet, LTE, and the like.

The coordination protocol field 2114 may indicate the coordination protocols used by the provider coordinator.

While the Provider Coordinator element may be an information element, fields or subfields thereof may be part of an element, sub-element, action frame, or action without ACK frame, or any management, control, or extension frames.

An AP deployed by a provider may be preconfigured and/or updated with Provider Coordinator information, which may be stored in the AP's management information base (MIB). An AP may include a Provider Coordinator element in its beacon, short beacon, or any other types of management, control, or extension frames. Another AP, when receiving such information, may forward the information to its own Provider Coordinator with additional information on the network, which may include the transmitting AP, such as operating channels, admission capabilities, probe request frequencies, access parameters, and the like.

A Provider Coordinator may collect information from APs of the same provider from its area, such as interference, performance, and/or information on BSSs from the same coverage area that may belong to other providers. This may leverage interference reporting methods.

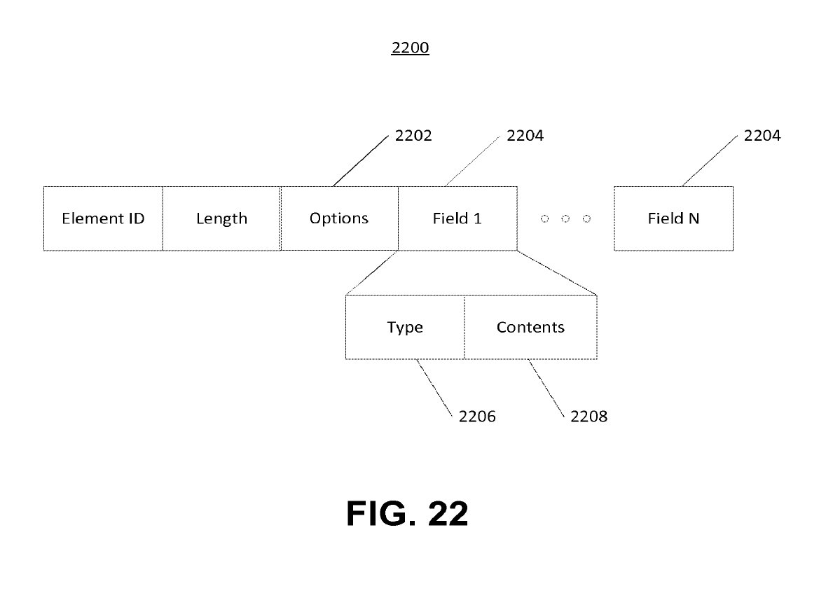

A Provider Coordinator may request coordination with the other Provider Coordinators of the overlapping networks deployed by other providers using a frame containing a Coordination Request IE 2200, an example of which is shown in FIG. 22. The Coordination Request IE 2200 may include an options field 2202 and fields 2204.

The options field 2202 may indicate various options for the coordination and may include a sequence number that may identify the coordination request, a type of request, and/or the number of fields contained in the coordination request. The type of request may be, for example, a request for information (e.g., requesting settings and parameters from the destination Provider Coordinator) or a request for coordination with or without a list of proposed settings.

The options field 2202 may include the types of parameters included in the Coordination Request IE 2200. Potential values may include Number of STAs per AP, Level of Service, Operating Channels, etc.

The fields 2204 may include one or more types of parameters that may be subject to coordination. The fields 2204 may include a type subfield 2206 that may indicate the type of parameters specified in the field 2204. Potential values may include Number of STAs per AP, Level of Service, Operating Channels, etc.

The fields 2204 may include a contents subfield 2208 that may specify the parameters indicated by the type subfield 2206. If the type subfield 2206 has a value of Number of STAs per AP, the contents subfield 2208 may indicate an upper limit of the number of STAs with which an AP is allowed to associate.

If the type subfield 2206 has a value of Level of Service, the contents subfield 2208 may indicate the level of services that may be associated with different Access Categories, such as AC_VI, AC_VO, AC_BK, AC_BE, AC_RealTimeVideo, AC_VideoGaming, AC_WirelessDisplay, etc. The level of service may be associated with different subscription levels, such as Premium, Silver, Regular, etc. Each level of service may be specified using parameters. For example, minimum and maximum service interval parameters may specify a minimal and/or maximal interval that an AC or STA of a certain level should be serviced in order to guarantee the associated criteria. Minimum and maximum throughput parameters may specify a minimal and/or maximal throughput level that an AC or STA of a certain level should be serviced in order to guarantee the associated criteria. Another parameter may specify a limitation on the number of STAs that may be allowed to be admitted at a given level of service. Another parameter may specify a limitation on the number of traffic streams that may be allowed to be admitted at a given level of service.

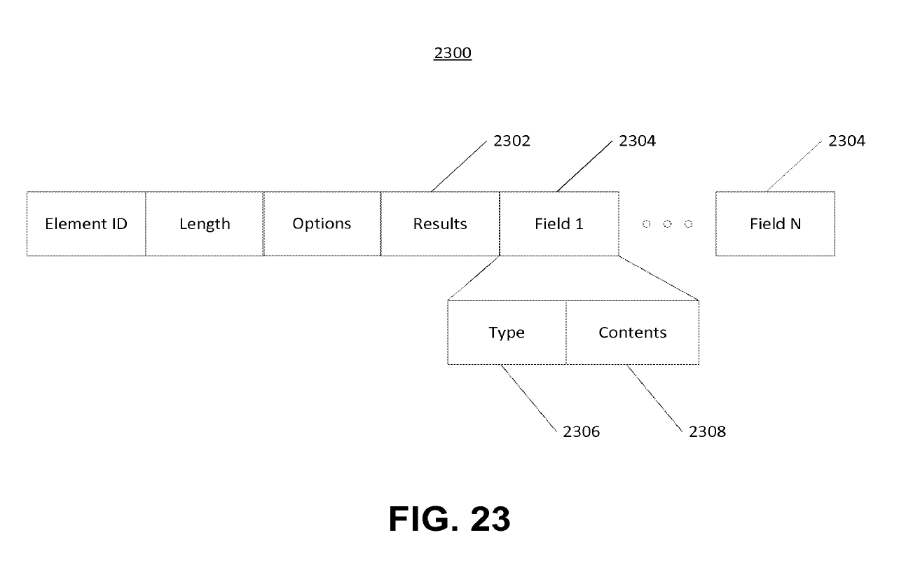

When requested by another Provider Coordinator, a Provider Coordinator may respond with a frame containing a Coordination Response information element (IE) 2300, an example of which is shown in FIG. 23. The Coordination Response IE 2300 may include a Results field 2302 that may indicate the status of the Coordination Request and may have potential values of Success, Reject, or Alternative values. The Results field may provide information on current settings and parameters requested. The Coordination Response IE 2300 may have fields 2304 that may include respective type subfields 2306 and contents subfields 2308. The type subfield 2306 may indicate that a corresponding contents subfield 2308 may contain alternative values for Number of STAs per AP, Operating Channels, Level of Services, etc., that the transmitting STA proposes, which may be different from the original values indicated in the Coordination Request IE.

The Coordination Request IE or the Coordination Response IE or any subset of the fields or subfields thereof may be implemented as a field or subfield or subsets of subfields of an IE, or as a part of any control, management, or other type of frames or in MAC/PLCP headers.

A Provider Coordinator may request information from other Provider Coordinators, e.g., from the same or overlapping coverage areas. A Provider Coordinator may request coordination on settings and parameters using proposed settings and parameters. For example, when receiving a Coordination Request (e.g., from another Provider Coordinator) for example, a Provider Coordinator may send information on its own settings and parameters. The Provider Coordinator that requested/received the parameters and/or settings may evaluate whether received parameters and/or settings are acceptable, e.g., if it is requested to conduct coordination. The Provider Coordinator may evaluate the received parameters and/or settings by determining whether the received parameters and/or settings impact current parameters and/or settings of one or more providers. A requesting Provider Coordinator (e.g., a Provider Coordinator that requested/received parameters and/or settings from another Provider Coordinator) may respond with a result code Success, e.g., if the parameters and/or settings are acceptable. The requesting Provider Coordinator may reject the settings and/or parameters, e.g., if the settings and/or parameters are not acceptable. The requesting Provider Coordinator may provide settings that may be acceptable to the requesting Provider Coordinator. A requesting Provider Coordinator may start using new settings and parameters when other Provider Coordinators (e.g., all Provider Coordinators located within a defined area) have accepted its request. Once the new setting is accepted, the Provider Coordinator may configure its APs in the coverage area using the new parameters and settings.

For example, a Provider Coordinator, at the trigger of the APs in its coverage area, or autonomously or periodically, may evaluate the performance of the BSSs in its coverage area. It may coordinate with the Provider Coordinators in the overlapping coverage area to limit the number of STAs that may be allowed to be associated with each AP. It may decrease the per STA throughput, e.g., if a BSS includes too many STAs. The performance of the BSSs in the overlapping or neighbor area may be degraded. By limiting the number of STAs per AP/BSS, each provider may ensure a certain level of performance for its subscribers. If the Provider Coordinators in a coverage area agree on the maximum number of STAs that may be allowed to associate with each AP, such a configuration may be distributed by each Provider Coordinator to the APs deployed by the same provider in its coverage area.

A Provider Coordinator, either at the trigger of the APs in its coverage area, or autonomously or periodically, may evaluate the performance of the BSSs in its coverage area. It may coordinate with all the Provider Coordinators in the overlapping coverage area, e.g., to guarantee different levels of services that may be provided by different Access Categories or levels of subscriptions. If providers are configured to provide unconstrained service to subscribers, there may be too much traffic load in the coverage area due to increased medium contention and limited resources. Subscribers (e.g., all subscribers) may be unable to expect a satisfactory level of services. By limiting the number of STAs or traffic streams allowed at certain levels of service per AP as well as determining the minimal and maximal service criteria for each level of services, a provider may ensure that its subscribers associated with a level of service or subscription (such as premium, gold, or basic) may be serviced with certain service standards. If the Provider Coordinators in a coverage area agree on the level of service specifications that may be allowed for each AP/BSS, such a configuration may be distributed by each Provider Coordinator to the APs deployed by the same provider in its coverage area.

A Provider Coordinator, either at the trigger of the APs in its coverage area, or autonomously or periodically, may evaluate the performance of the BSSs in its coverage area. It may coordinate with the Provider Coordinators in the overlapping coverage area, e.g., to identify their primary channels, secondary channels, and corresponding priorities on the channels. If the providers realize that there is an overlap (e.g., above a threshold) between primary channels or that a change in the priority of a provider on a certain channel may improve the performance of the network, such configuration may be distributed to a Provider Coordinator and in turn by each Provider Coordinator to the APs deployed by the same provider in its coverage area.

A multi-level or hierarchical carrier sensing mechanism may be adapted for multiple service providers. A hierarchical carrier sensing and medium reservation mechanism may be disclosed herein. A group of nodes may compete to reserve a set of resources (e.g., time, frequency, or code), e.g., at each level. The resources reserved may be accessed by the nodes in that group using CSMA/CA. A provider may lease (e.g., be granted access to use) the resources, for example for a desired duration. Nodes associated with the provider (e.g., AP and/or STA) may access the resources using CSMA/CA, e.g., when the provider is granted a lease. The effect of a high number of STAs per AP may be reduced, e.g., by granting a lease to less than all providers for a given time period. Channel reuse may be enabled, and, multi-provider cooperation may be enhanced.

As an example, a multi-provider network may include three providers (e.g., provider 1, provider 2, and provider 3). Resource allocation may include one or more of the following. Providers may contend for network access. A central controller may grant access to a subset of the providers (e.g., may limit network access to one provider). A provider that has been granted access may reserve the channel (e.g., for a specific time duration). APs and/or STAs associated with the provider that successfully reserved the channel may contend with each other to transmit data over the reserved channel, e.g., during the time successfully reserved by the provider.

Provider contention may be performed, which may be considered contention at a first level, (e.g., provider-level contention). Providers (e.g., respective Provider Coordinator associated with respective providers) may contend for network access (for example, a Group Transmission Opportunity), which may be subject to a time limit (e.g., a Group Transmission Opportunity Limit). The contention may include one or more of the following.

AP(s) belonging to a provider may contend for the channel using CSMA/CA. A provider (e.g., an enterprise network that may have two or more APs) may select an AP/node, or a subset of APs/nodes, to contend for the medium on behalf of the provider (e.g., a provider coordinator(s)). Each of the multiple providers may select such AP(s)/node(s). The xIFS and back-off durations may be tied to the provider, and may be independent of the xIFSs/back-off durations of their constituent or dependent nodes. This may ensure that the priority with which each provider contends for the medium may be independent of the priority with which the provider's constituent nodes contend for the medium.

Provider(s) (e.g., an enterprise network that may have two or more APs) may use an auction based method to contend for the channel. A provider may elect an auctioneer or auctioneers (e.g., Provider Coordinator(s)) that may broadcast a utility metric (e.g., Network Throughput, Network Energy Level, Network Interference Level, Channel Selection Cost, etc.). A granting entity, e.g., a central controller, may compare the utility metrics to determine a most favorable utility metric and grant access based on the most favorable utility metric, for example, to a provider associated with the most favorable utility metric. The provider with the most favorable utility metric may gain access (e.g., be granted access and gain access) to the channel, e.g., as disclosed herein.

A utility metric may be performance based, e.g., may result from the average throughput and/or interference experienced by a provider. The provider with a lowest utility metric for throughput may access the channel (e.g., a provider that has a low throughput, for example because the provider is getting limited access to the channel, may be deemed to have the most favorable utility metric and be granted access to the channel). The utility metric may result from an amount of interference received by the provider. The provider with a lowest utility metric for interference may access the channel (e.g., a provider which supports advanced interference suppression methods such as beamforming may be granted access to the channel).

The utility metric may not be performance based, e.g., it may be based on a bid, payment, charge, preferred provider, etc. The utility metric may result from an instantaneous tax or payment, e.g., to a central entity. The provider with a highest metric for a proposed payment may access the channel (e.g., the provider paying a highest payment may be granted access to the channel). The metric may result from parameters received from a centralized database. The database operator may determine who may access the channel. A utility metric may include a plurality of factors, e.g., one or more performance based factors and/or one or more non-performance based factors, where the factors may be weighted. The determined most favorable utility metric may be a result of an evaluation of the multiple factors in each utility metric.

The provider may reserve the channel for a specific duration, e.g., when the provider is granted channel access. One or more of the following may apply.

A provider (e.g., a provider that has been granted channel access) may send a Group Transmit Opportunity (GTxOP) request. The GTxOP request may include a GTxOP duration. The GTxOP duration may be less than or equal to a GTxOP limit (e.g., a GTxOP limit set by the granting entity, for example the central controller). The provider may have preferred access (e.g., exclusive access) to the medium, e.g., as specified in the grant. The preferred access may be for a duration, e.g., the GTxOP duration.

A provider (e.g., a provider that has been granted channel access) may use a Restricted Access Window(s) (e.g., a modified Restricted Access Window(s)), periodicity, and/or grouping. A channel access (e.g., uplink and/or downlink transmission) may be restricted to a specific provider for a given duration (e.g., GTxOP duration). The provider that reserves the channel and the duration of the window may be based on provider contention disclosed herein. This information may be broadcast in a beacon, short beacon, or other types of management, control, or extension frames, which may be implemented as a field of an IE, a subfield of an IE, a subset(s) of subfields of an IE, as a part of a control or management frame, or in a MAC/PLCP header(s).

A provider (e.g., a provider that has been granted channel access) may use a Target Wake Time(s) (e.g., modified Target Wake Time(s)), periodicity, and/or grouping. STAs belonging to a specific provider may be woken up (e.g., by a provider coordinator) at specific times and/or for specific durations to access the medium. The provider that reserves the channel and the duration of the window may be based on provider contention disclosed herein. The operation may be explicit. Nodes (e.g., AP(s) or STA(s)) belonging to a specific provider may be informed of a time (e.g., an exact time) at which the node may need to turn on. The operation may be implicit. A wake interval parameter may be added to the current target wake time, e.g., to determine when a node may turn on. This information may be broadcast in a beacon, short beacon, or other types of management, control or extension frames, which may be implemented as a field of an IE, a subfield of an IE, a subset(s) of subfields of an IE, as a part of a control or management frame, or in a MAC/PLCP header(s).

A provider (e.g., a provider that has been granted channel access) may use Adjacent BSS quieting (e.g., modified Adjacent BSS quieting). Nodes (e.g., APs or STAB) belonging to the provider may send BSS quieting requests to APs/STAs that belong to other providers that may impact their performance.

Nodes associated with a provider may contend for access, which may be considered contention at a second level. Nodes of a provider (e.g., APs and STAB) may also contend (e.g., with each other) to transmit data for the duration associated with the Group Transmission Opportunity, for example once the provider has successfully contended for the medium. Examples of contention may include EDCA-TXoP, HCCA-TxOP or polled TxOP AP/STA access within each provider, OFDMA, and/or Coordinated Orthogonal Block-based Resource Allocation (COBRA) within each provider.

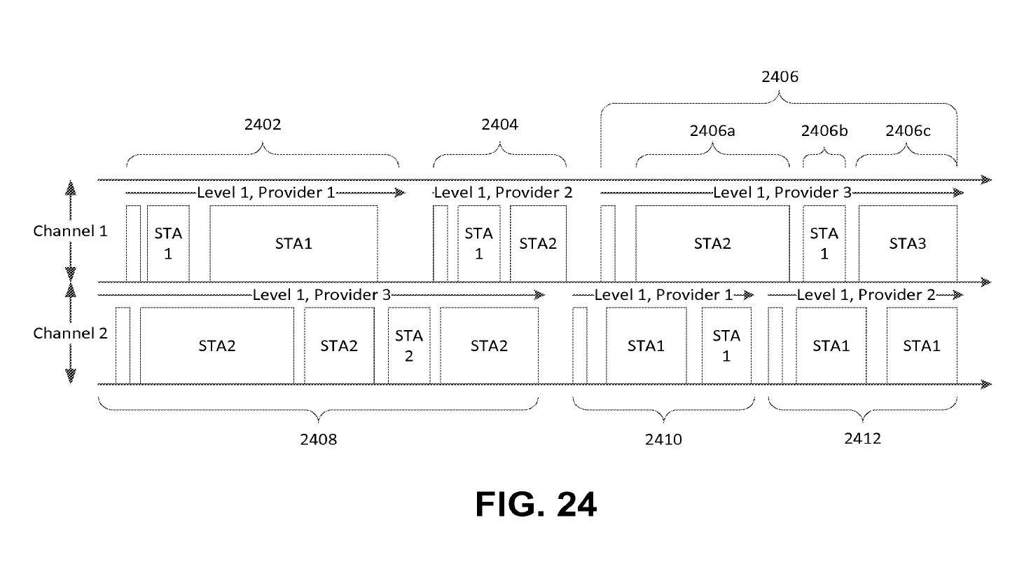

In scenarios where there are multiple channels, a (e.g., hierarchical) multi-provider network access may be implemented independently per channel, or per a group of channels and/or sub-channels, e.g., as shown in FIG. 24. An independent network access procedure may be implemented for each channel, e.g., channels 1 and 2, using channel contention as disclosed herein for example. A granting entity, e.g., a central controller, may grant provider 1 access to channel 1 during a first time duration 2402. The granting entity may grant provider 2 with access to channel 1 during a second time duration 2404. The granting entity may grant provider 3 with access to channel 1 during a third time duration 2406. The granting entity may grant provider 3 with access to channel 2 during a fourth time duration 2408. The granting entity may grant provider 1 with access to channel 2 during a fifth time duration 2410. The granting entity may grant provider 2 with access to channel 2 during a sixth time duration 2412. The granting entity may control access to channels 1 and 2.

Nodes (e.g., APs/STAs) of a provider may contend with each other for access to a channel for which the provider has been granted access. For example, STA1, STA2, and STA3 of provider 3 may contend with each other for access to channel 1 during the time duration 2406. As illustrated, STA2 may obtain access to channel 1 for a time duration 2406a. STA1 may obtain access to channel 1 for a time duration 2406b. STA3 may obtain access to channel 1 for a time duration 2406c.

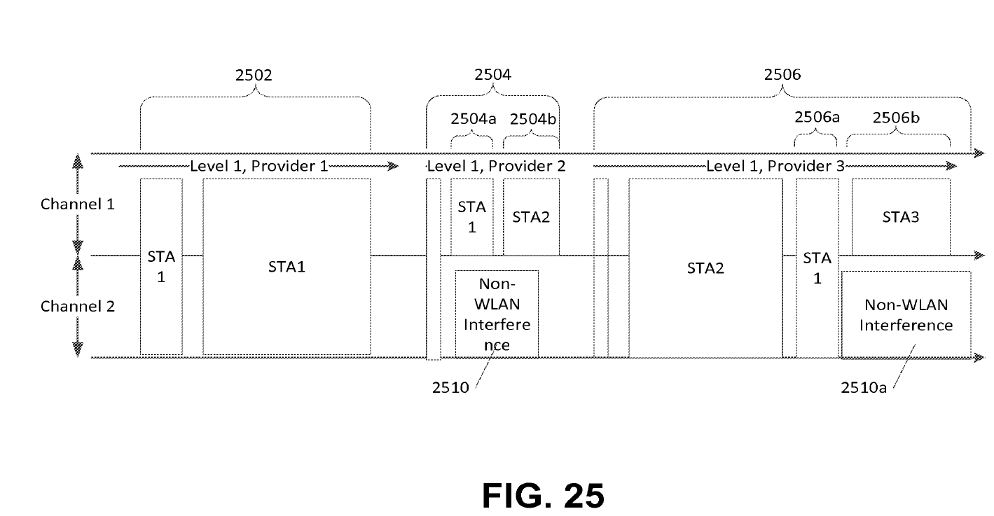

A hierarchical multi-provider network access may be implemented on a (e.g., primary) channel (e.g., only on the primary channel, for example channel 1), with additional clear channel assessments performed on another channel (e.g., a secondary channel, for example channel 2) as illustrated in FIG. 25. The additional clear channel assessments may be performed by a node (e.g., a STA) that has been granted access. A granting entity (e.g., a central controller) may grant provider 1 access to channels 1 and 2 during a time duration 2502. The granting entity may grant provider 2 access to channels 1 and 2 during a time duration 2504. The granting entity may grant provider 3 access to channels 1 and 2 during a time duration 2504.

Within the time duration 2504, a granting entity (e.g., a provider coordinator) may grant STA1 of provider 2 access to channels 1 and 2 during a time duration 2504a. The granting entity (e.g., a provider coordinator) may grant ST_{A2} of provider 2 access to channels 1 and 2 during a time duration 2504b. STA1 of provider 2 may perform a clear channel assessment on channel 2, e.g., before it transmits data. STA1 of provider 2 may determine, e.g., based on the clear channel assessment, that there is (e.g., non-WLAN) interference 2510 on channel 2. STA1 of provider 2 may transmit data (e.g., only transmit data) on channel 1 and not on channel 2, e.g., due to the interference 2510 on channel 2.

Based on a time duration of the interference on the secondary channel, a node of a provider may transmit on the primary channel and the secondary channel while another node of the provider may transmit (e.g., only transmit) on the primary channel and not on the secondary channel. An interference 2510a may not exist for the entire time duration 2506 that a provider (e.g., provider 3) has been granted access. The interference 2510a may (e.g., only) exist for a portion of the time duration 2506. STA1 of provider 3 may transmit over channels 1 and 2, e.g., because the interference 2510a does not exist during a time duration 2506a. STA3 of provider 3 may not transmit over channel 2 and may transmit (e.g., only transmit) over channel 1, e.g., due to the interference 2510a.

A first STA of a provider may transmit on the primary channel and the secondary channel while a second STA of the provider may transmit (e.g., only transmit) on the primary channel and not on the secondary channel, e.g., based on clear channel assessment (CCA) thresholds of the STAs. For example, the first STA may have a relatively high CCA threshold (e.g., higher than the second STA) and the second STA may have a relatively low CCA threshold. An interference level on the secondary channel may be lower than the higher CCA threshold o and higher than the lower CCA threshold.

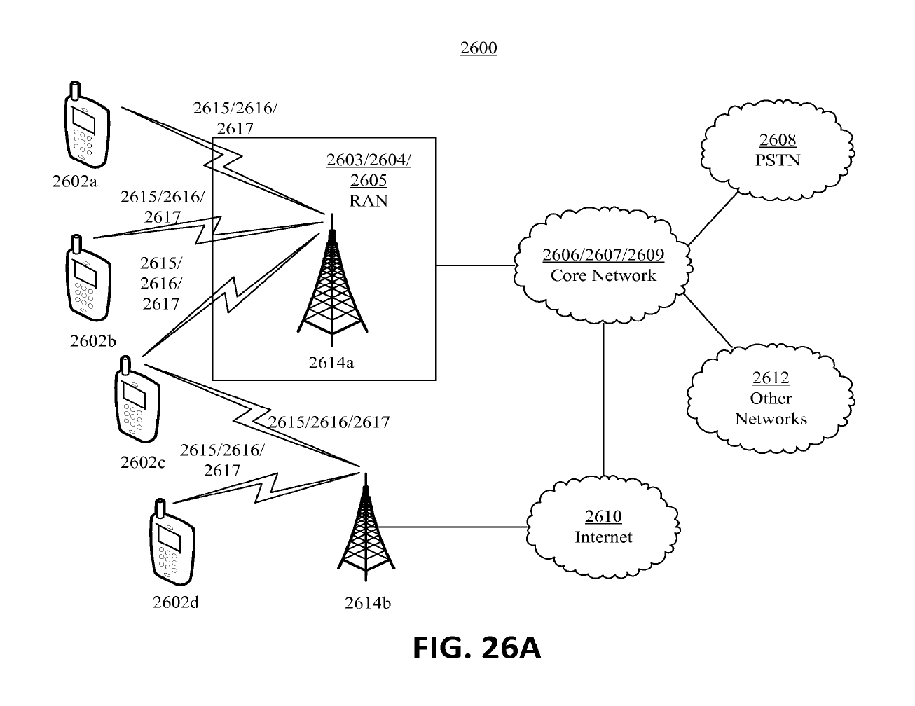

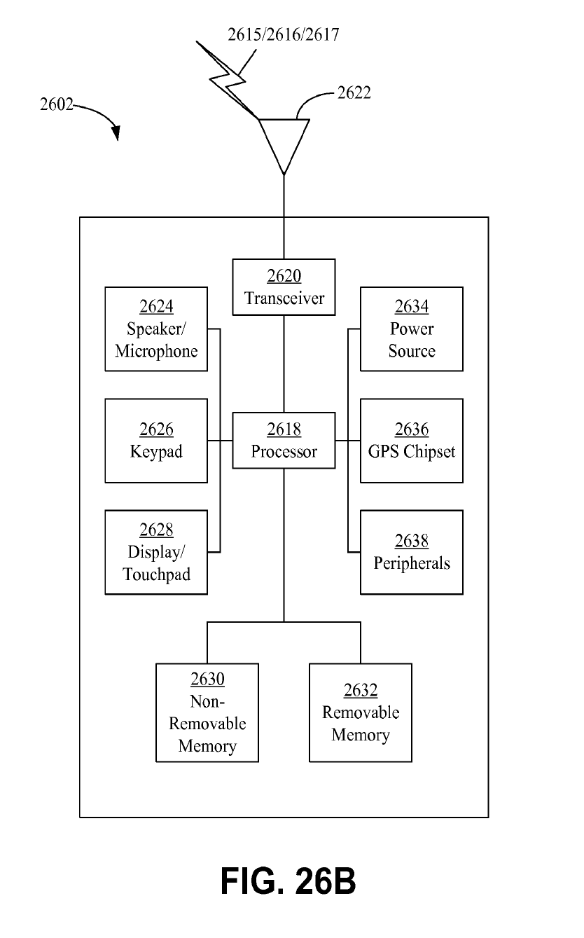

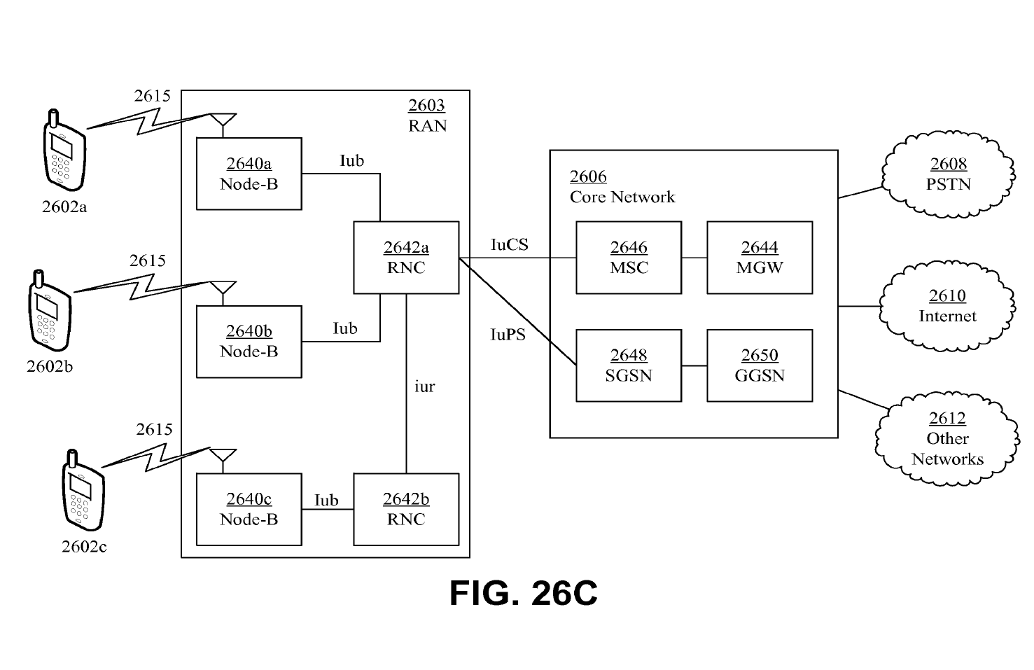

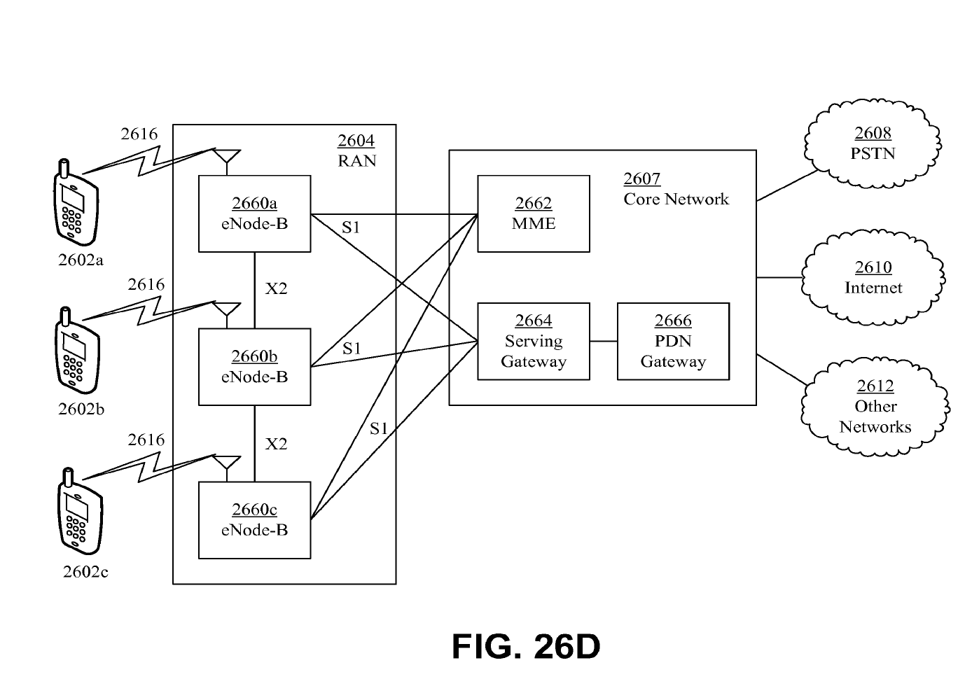

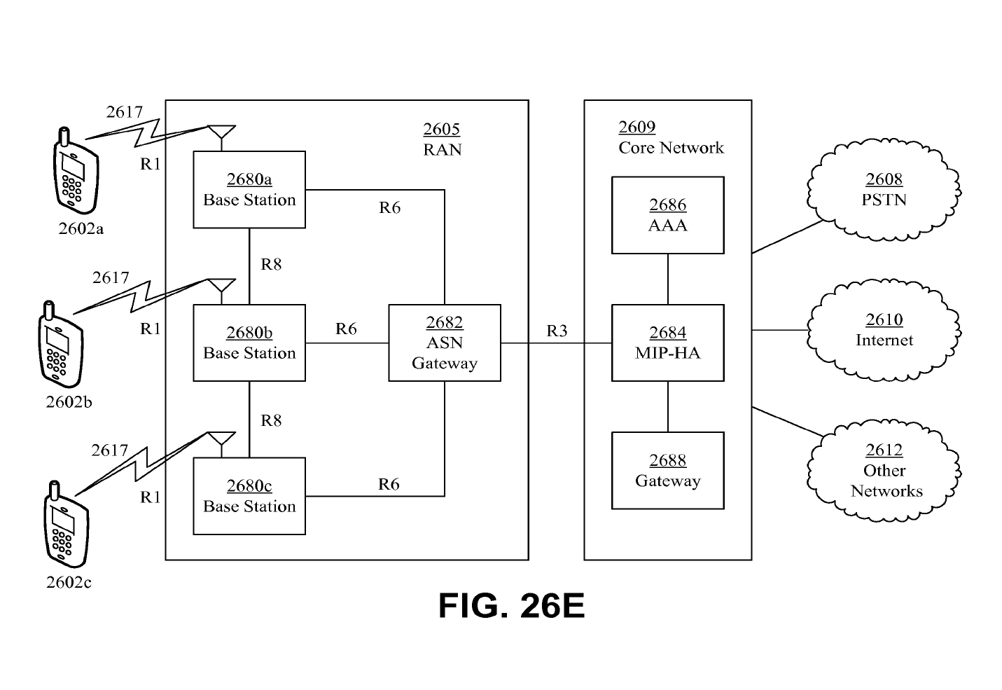

FIG. 26A is a diagram of an example communications system 2600 in which one or more disclosed embodiments may be implemented. The communications system 2600 may be a multiple access system that provides content, such as voice, data, video, messaging, broadcast, etc., to multiple wireless users. The communications system 2600 may enable multiple wireless users to access such content through the sharing of system resources, including wireless bandwidth. For example, the communications system 2600 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 26A, the communications system 2600 may include wireless transmit/receive units (WTRUs) 2602a, 2602b, 2602c, and/or 2602d (which generally or collectively may be referred to as WTRU 2602), a radio access network (RAN) 2603/2604/2605, a core network 2606/2607/2609, a public switched telephone network (PSTN) 2608, the Internet 2610, and other networks 2612, though it will be appreciated that the disclosed embodiments contemplate any number of WTRUs, base stations, networks, and/or network elements. Each of the WTRUs 2602a, 2602b, 2602c, 2602d may be any type of device configured to operate and/or communicate in a wireless environment. By way of example, the WTRUs 2602a, 2602b, 2602c, 2602d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 2600 may also include a base station 2614a and a base station 2614b. Each of the base stations 2614a, 2614b may be any type of device configured to wirelessly interface with at least one of the WTRUs 2602a, 2602b, 2602c, 2602d to facilitate access to one or more communication networks, such as the core network 2606/2607/2609, the Internet 2610, and/or the networks 2612. By way of example, the base stations 2614a, 2614b may be a base transceiver station (BTS), a Node-B, an eNode B, a Home Node B, a Home eNode B, a site controller, an access point (AP), a wireless router, and the like. While the base stations 2614a, 2614b are each depicted as a single element, it will be appreciated that the base stations 2614a, 2614b may include any number of interconnected base stations and/or network elements.

The base station 2614a may be part of the RAN 2603/2604/2605, which may also include other base stations and/or network elements (not shown), such as a base station controller (BSC), a radio network controller (RNC), relay nodes, etc. The base station 2614a and/or the base station 2614b may be configured to transmit and/or receive wireless signals within a particular geographic region, which may be referred to as a cell (not shown). The cell may further be divided into cell sectors. For example, the cell associated with the base station 2614a may be divided into three sectors. Thus, in one embodiment, the base station 2614a may include three transceivers, e.g., one for each sector of the cell. In another embodiment, the base station 2614a may employ multiple-input multiple output (MIMO) technology and, therefore, may utilize multiple transceivers for each sector of the cell.

The base stations 2614a, 2614b may communicate with one or more of the WTRUs 2602a, 2602b, 2602c, 2602d over an air interface 2615/2616/2617, which may be any suitable wireless communication link (e.g., radio frequency (RF), microwave, infrared (IR), ultraviolet (UV), visible light, etc.). The air interface 2615/2616/2617 may be established using any suitable radio access technology (RAT).

More specifically, as noted above, the communications system 2600 may be a multiple access system and may employ one or more channel access schemes, such as CDMA, TDMA, FDMA, OFDMA, SC-FDMA, and the like. For example, the base station 2614a in the RAN 2603/2604/2605 and the WTRUs 2602a, 2602b, 2602c may implement a radio technology such as Universal Mobile Telecommunications System (UMTS) Terrestrial Radio Access (UTRA), which may establish the air interface 2615/2616/2617 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 2614a and the WTRUs 2602a, 2602b, 2602c may implement a radio technology such as Evolved UMTS Terrestrial Radio Access (E-UTRA), which may establish the air interface 2615/2616/2617 using Long Term Evolution (LTE) and/or LTE-Advanced (LTE-A).

In other embodiments, the base station 2614a and the WTRUs 2602a, 2602b, 2602c may implement radio technologies such as IEEE 802.16 (e.g., Worldwide Interoperability for Microwave Access (WiMAX)), CDMA2000, CDMA2000 1x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 2614b in FIG. 26A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 2614b and the WTRUs 2602c, 2602d may implement a radio technology such as IEEE 802.11 to establish a wireless local area network (WLAN). In another embodiment, the base station 2614b and the WTRUs 2602c, 2602d may implement a radio technology such as IEEE 802.15 to establish a wireless personal area network (WPAN). In yet another embodiment, the base station 2614b and the WTRUs 2602c, 2602d may utilize a cellular-based RAT (e.g., WCDMA, CDMA2000, GSM, LTE, LTE-A, etc.) to establish a picocell or femtocell. As shown in FIG. 26A, the base station 2614b may have a direct connection to the Internet 2610. Thus, the base station 2614b may not be required to access the Internet 2610 via the core network 2606/2607/2609.

The RAN 2603/2604/2605 may be in communication with the core network 2606/2607/2609, which may be any type of network configured to provide voice, data, applications, and/or voice over internet protocol (VoIP) services to one or more of the WTRUs 2602a, 2602b, 2602c, 2602d. For example, the core network 2606/2607/2609 may provide call control, billing services, mobile location-based services, pre-paid calling, Internet connectivity, video distribution, etc., and/or perform high-level security functions, such as user authentication. Although not shown in FIG. 26A, it will be appreciated that the RAN 2603/2604/2605 and/or the core network 2606/2607/2609 may be in direct or indirect communication with other RANs that employ the same RAT as the RAN 2603/2604/2605 or a different RAT. For example, in addition to being connected to the RAN 2603/2604/2605, which may be utilizing an E-UTRA radio technology, the core network 2606/2607/2609 may also be in communication with another RAN (not shown) employing a GSM radio technology.

The core network 2606/2607/2609 may also serve as a gateway for the WTRUs 2602a, 2602b, 2602c, 2602d to access the PSTN 2608, the Internet 2610, and/or other networks 2612. The PSTN 2608 may include circuit-switched telephone networks that provide plain old telephone service (POTS). The Internet 2610 may include a global system of interconnected computer networks and devices that use common communication protocols, such as the transmission control protocol (TCP), user datagram protocol (UDP) and the internet protocol (IP) in the TCP/IP internet protocol suite. The networks 2612 may include wired or wireless communications networks owned and/or operated by other service providers. For example, the networks 2612 may include another core network connected to one or more RANs, which may employ the same RAT as the RAN 2603/2604/2605 or a different RAT.

Some or all of the WTRUs 2602a, 2602b, 2602c, 2602d in the communications system 2600 may include multi-mode capabilities, e.g., the WTRUs 2602a, 2602b, 2602c, 2602d may include multiple transceivers for communicating with different wireless networks over different wireless links. For example, the WTRU 2602c shown in FIG. 26A may be configured to communicate with the base station 2614a, which may employ a cellular-based radio technology, and with the base station 2614b, which may employ an IEEE 802 radio technology.

FIG. 26B is a system diagram of an example WTRU 2602. As shown in FIG. 26B, the WTRU 2602 may include a processor 2618, a transceiver 2620, a transmit/receive element 2622, a speaker/microphone 2624, a keypad 2626, a display/touchpad 2628, non-removable memory 2630, removable memory 2632, a power source 2634, a global positioning system (GPS) chipset 2636, and other peripherals 2638. It will be appreciated that the WTRU 2602 may include any sub-combination of the foregoing elements while remaining consistent with an embodiment. Also, embodiments contemplate that the base stations 2614a and 2614b, and/or the nodes that base stations 2614a and 2614b may represent, such as but not limited to transceiver station (BTS), a Node-B, a site controller, an access point (AP), a home node-B, an evolved home node-B (eNodeB), a home evolved node-B (HeNB or HeNodeB), a home evolved node-B gateway, and proxy nodes, among others, may include some or all of the elements depicted in FIG. 26B and described herein.

The processor 2618 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 2618 may perform signal coding, data processing, power control, input/output processing, and/or any other functionality that enables the WTRU 2602 to operate in a wireless environment. The processor 2618 may be coupled to the transceiver 2620, which may be coupled to the transmit/receive element 2622. While FIG. 26B depicts the processor 2618 and the transceiver 2620 as separate components, it will be appreciated that the processor 2618 and the transceiver 2620 may be integrated together in an electronic package or chip.

The transmit/receive element 2622 may be configured to transmit signals to, or receive signals from, a base station (e.g., the base station 2614a) over the air interface 2615/2616/2617. For example, in one embodiment, the transmit/receive element 2622 may be an antenna configured to transmit and/or receive RF signals. In another embodiment, the transmit/receive element 2622 may be an emitter/detector configured to transmit and/or receive IR, UV, or visible light signals, for example. In yet another embodiment, the transmit/receive element 2622 may be configured to transmit and receive both RF and light signals. It will be appreciated that the transmit/receive element 2622 may be configured to transmit and/or receive any combination of wireless signals.

In addition, although the transmit/receive element 2622 is depicted in FIG. 26B as a single element, the WTRU 2602 may include any number of transmit/receive elements 2622. More specifically, the WTRU 2602 may employ MIMO technology. Thus, in one embodiment, the WTRU 2602 may include two or more transmit/receive elements 2622 (e.g., multiple antennas) for transmitting and receiving wireless signals over the air interface 2615/2616/2617.

The transceiver 2620 may be configured to modulate the signals that are to be transmitted by the transmit/receive element 2622 and to demodulate the signals that are received by the transmit/receive element 2622. As noted above, the WTRU 2602 may have multi-mode capabilities. Thus, the transceiver 2620 may include multiple transceivers for enabling the WTRU 2602 to communicate via multiple RATs, such as UTRA and IEEE 802.11, for example.

The processor 2618 of the WTRU 2602 may be coupled to, and may receive user input data from, the speaker/microphone 2624, the keypad 2626, and/or the display/touchpad 2628 (e.g., a liquid crystal display (LCD) display unit or organic light-emitting diode (OLED) display unit). The processor 2618 may also output user data to the speaker/microphone 2624, the keypad 2626, and/or the display/touchpad 2628. In addition, the processor 2618 may access information from, and store data in, any type of suitable memory, such as the non-removable memory 2630 and/or the removable memory 2632. The non-removable memory 2630 may include random-access memory (RAM), read-only memory (ROM), a hard disk, or any other type of memory storage device. The removable memory 2632 may include a subscriber identity module (SIM) card, a memory stick, a secure digital (SD) memory card, and the like. In other embodiments, the processor 2618 may access information from, and store data in, memory that is not physically located on the WTRU 2602, such as on a server or a home computer (not shown).

The processor 2618 may receive power from the power source 2634, and may be configured to distribute and/or control the power to the other components in the WTRU 2602. The power source 2634 may be any suitable device for powering the WTRU 2602. For example, the power source 2634 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 2618 may also be coupled to the GPS chipset 2636, which may be configured to provide location information (e.g., longitude and latitude) regarding the current location of the WTRU 2602. In addition to, or in lieu of, the information from the GPS chipset 2636, the WTRU 2602 may receive location information over the air interface 2615/2616/2617 from a base station (e.g., base stations 2614a, 2614b) and/or determine its location based on the timing of the signals being received from two or more nearby base stations. It will be appreciated that the WTRU 2602 may acquire location information by way of any suitable location-determination implementation while remaining consistent with an embodiment.

The processor 2618 may further be coupled to other peripherals 2638, which may include one or more software and/or hardware modules that provide additional features, functionality and/or wired or wireless connectivity. For example, the peripherals 2638 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 26C is a system diagram of the RAN 2603 and the core network 2606 according to an embodiment. As noted above, the RAN 2603 may employ a UTRA radio technology to communicate with the WTRUs 2602a, 2602b, 2602c over the air interface 2615. The RAN 2603 may also be in communication with the core network 2606. As shown in FIG. 26C, the RAN 2603 may include Node-Bs 2640a, 2640b, 2640c, which may each include one or more transceivers for communicating with the WTRUs 2602a, 2602b, 2602c over the air interface 2615. The Node-Bs 2640a, 2640b, 2640c may each be associated with a particular cell (not shown) within the RAN 2603. The RAN 2603 may also include RNCs 2642a, 2642b. It will be appreciated that the RAN 2603 may include any number of Node-Bs and RNCs while remaining consistent with an embodiment.

As shown in FIG. 26C, the Node-Bs 2640a, 2640b may be in communication with the RNC 2642a. Additionally, the Node-B 2640c may be in communication with the RNC 2642b. The Node-Bs 2640a, 2640b, 2640c may communicate with the respective RNCs 2642a, 2642b via an Iub interface. The RNCs 2642a, 2642b may be in communication with one another via an Iur interface. Each of the RNCs 2642a, 2642b may be configured to control the respective Node-Bs 2640a, 2640b, 2640c to which it is connected. In addition, each of the RNCs 2642a, 2642b may be configured to carry out or support other functionality, such as outer loop power control, load control, admission control, packet scheduling, handover control, macrodiversity, security functions, data encryption, and the like.

The core network 2606 shown in FIG. 26C may include a media gateway (MGW) 2644, a mobile switching center (MSC) 2646, a serving GPRS support node (SGSN) 2648, and/or a gateway GPRS support node (GGSN) 2650. While each of the foregoing elements are depicted as part of the core network 2606, it will be appreciated that any one of these elements may be owned and/or operated by an entity other than the core network operator.

The RNC 2642a in the RAN 2603 may be connected to the MSC 2646 in the core network 2606 via an IuCS interface. The MSC 2646 may be connected to the MGW 2644. The MSC 2646 and the MGW 2644 may provide the WTRUs 2602a, 2602b, 2602c with access to circuit-switched networks, such as the PSTN 2608, to facilitate communications between the WTRUs 2602a, 2602b, 2602c and traditional land-line communications devices.

The RNC 2642a in the RAN 2603 may also be connected to the SGSN 2648 in the core network 2606 via an IuPS interface. The SGSN 2648 may be connected to the GGSN 2650. The SGSN 2648 and the GGSN 2650 may provide the WTRUs 2602a, 2602b, 2602c with access to packet-switched networks, such as the Internet 2610, to facilitate communications between and the WTRUs 2602a, 2602b, 2602c and IP-enabled devices.

As noted above, the core network 2606 may also be connected to the networks 2612, which may include other wired or wireless networks that are owned and/or operated by other service providers.

FIG. 26D is a system diagram of the RAN 2604 and the core network 2607 according to an embodiment. As noted above, the RAN 2604 may employ an E-UTRA radio technology to communicate with the WTRUs 2602a, 2602b, 2602c over the air interface 2616. The RAN 2604 may also be in communication with the core network 2607.

The RAN 2604 may include eNode-Bs 2660a, 2660b, 2660c, though it will be appreciated that the RAN 2604 may include any number of eNode-Bs while remaining consistent with an embodiment. The eNode-Bs 2660a, 2660b, 2660c may each include one or more transceivers for communicating with the WTRUs 2602a, 2602b, 2602c over the air interface 2616. In one embodiment, the eNode-Bs 2660a, 2660b, 2660c may implement MIMO technology. Thus, the eNode-B 2660a, for example, may use multiple antennas to transmit wireless signals to, and receive wireless signals from, the WTRU 2602a.

Each of the eNode-Bs 2660a, 2660b, 2660c may be associated with a particular cell (not shown) and may be configured to handle radio resource management decisions, handover decisions, scheduling of users in the uplink and/or downlink, and the like. As shown in FIG. 26D, the eNode-Bs 2660a, 2660b, 2660c may communicate with one another over an X2 interface.

The core network 2607 shown in FIG. 26D may include a mobility management gateway (MME) 2662, a serving gateway 2664, and a packet data network (PDN) gateway 2666. While each of the foregoing elements are depicted as part of the core network 2607, it will be appreciated that any one of these elements may be owned and/or operated by an entity other than the core network operator.

The MME 2662 may be connected to each of the eNode-Bs 2660a, 2660b, 2660c in the RAN 2604 via an S1 interface and may serve as a control node. For example, the MME 2662 may be responsible for authenticating users of the WTRUs 2602a, 2602b, 2602c, bearer activation/deactivation, selecting a particular serving gateway during an initial attach of the WTRUs 2602a, 2602b, 2602c, and the like. The MME 2662 may also provide a control plane function for switching between the RAN 2604 and other RANs (not shown) that employ other radio technologies, such as GSM or WCDMA.

The serving gateway 2664 may be connected to each of the eNode-Bs 2660a, 2660b, 2660c in the RAN 2604 via the S1 interface. The serving gateway 2664 may generally route and forward user data packets to/from the WTRUs 2602a, 2602b, 2602c. The serving gateway 2664 may also perform other functions, such as anchoring user planes during inter-eNode B handovers, triggering paging when downlink data is available for the WTRUs 2602a, 2602b, 2602c, managing and storing contexts of the WTRUs 2602a, 2602b, 2602c, and the like.

The serving gateway 2664 may also be connected to the PDN gateway 2666, which may provide the WTRUs 2602a, 2602b, 2602c with access to packet-switched networks, such as the Internet 2610, to facilitate communications between the WTRUs 2602a, 2602b, 2602c and IP-enabled devices.

The core network 2607 may facilitate communications with other networks. For example, the core network 2607 may provide the WTRUs 2602a, 2602b, 2602c with access to circuit-switched networks, such as the PSTN 2608, to facilitate communications between the WTRUs 2602a, 2602b, 2602c and traditional land-line communications devices. For example, the core network 2607 may include, or may communicate with, an IP gateway (e.g., an IP multimedia subsystem (IMS) server) that serves as an interface between the core network 2607 and the PSTN 2608. In addition, the core network 2607 may provide the WTRUs 2602a, 2602b, 2602c with access to the networks 2612, which may include other wired or wireless networks that are owned and/or operated by other service providers.

FIG. 26E is a system diagram of the RAN 2605 and the core network 2609 according to an embodiment. The RAN 2605 may be an access service network (ASN) that employs IEEE 802.16 radio technology to communicate with the WTRUs 2602a, 2602b, 2602c over the air interface 2617. As will be further discussed below, the communication links between the different functional entities of the WTRUs 2602a, 2602b, 2602c, the RAN 2605, and the core network 2609 may be defined as reference points.

As shown in FIG. 26E, the RAN 2605 may include base stations 2680a, 2680b, 2680c, and an ASN gateway 2682, though it will be appreciated that the RAN 2605 may include any number of base stations and ASN gateways while remaining consistent with an embodiment. The base stations 2680a, 2680b, 2680c may each be associated with a particular cell (not shown) in the RAN 2605 and may each include one or more transceivers for communicating with the WTRUs 2602a, 2602b, 2602c over the air interface 2617. In one embodiment, the base stations 2680a, 2680b, 2680c may implement MIMO technology. Thus, the base station 2680a, for example, may use multiple antennas to transmit wireless signals to, and receive wireless signals from, the WTRU 2602a. The base stations 2680a, 2680b, 2680c may also provide mobility management functions, such as handoff triggering, tunnel establishment, radio resource management, traffic classification, quality of service (QoS) policy enforcement, and the like. The ASN gateway 2682 may serve as a traffic aggregation point and may be responsible for paging, caching of subscriber profiles, routing to the core network 2609, and the like.

The air interface 2617 between the WTRUs 2602a, 2602b, 2602c and the RAN 2605 may be defined as an R1 reference point that implements the IEEE 802.16 specification. In addition, each of the WTRUs 2602a, 2602b, 2602c may establish a logical interface (not shown) with the core network 2609. The logical interface between the WTRUs 2602a, 2602b, 2602c and the core network 2609 may be defined as an R2 reference point, which may be used for authentication, authorization, IP host configuration management, and/or mobility management.

The communication link between each of the base stations 2680a, 2680b, 2680c may be defined as an R8 reference point that includes protocols for facilitating WTRU handovers and the transfer of data between base stations. The communication link between the base stations 2680a, 2680b, 2680c and the ASN gateway 2682 may be defined as an R6 reference point. The R6 reference point may include protocols for facilitating mobility management based on mobility events associated with each of the WTRUs 2602a, 2602b, 2602c.

As shown in FIG. 26E, the RAN 2605 may be connected to the core network 2609. The communication link between the RAN 2605 and the core network 2609 may defined as an R3 reference point that includes protocols for facilitating data transfer and mobility management capabilities, for example. The core network 2609 may include a mobile IP home agent (MIP-HA) 2684, an authentication, authorization, accounting (AAA) server 2686, and a gateway 2688. While each of the foregoing elements are depicted as part of the core network 2609, it will be appreciated that any one of these elements may be owned and/or operated by an entity other than the core network operator.

The MIP-HA may be responsible for IP address management, and may enable the WTRUs 2602a, 2602b, 2602c to roam between different ASNs and/or different core networks. The MIP-HA 2684 may provide the WTRUs 2602a, 2602b, 2602c with access to packet-switched networks, such as the Internet 2610, to facilitate communications between the WTRUs 2602a, 2602b, 2602c and IP-enabled devices. The AAA server 2686 may be responsible for user authentication and for supporting user services. The gateway 2688 may facilitate interworking with other networks. For example, the gateway 2688 may provide the WTRUs 2602a, 2602b, 2602c with access to circuit-switched networks, such as the PSTN 2608, to facilitate communications between the WTRUs 2602a, 2602b, 2602c and traditional land-line communications devices. In addition, the gateway 2688 may provide the WTRUs 2602a, 2602b, 2602c with access to the networks 2612, which may include other wired or wireless networks that are owned and/or operated by other service providers.

Although not shown in FIG. 26E, it will be appreciated that the RAN 2605 may be connected to other ASNs and the core network 2609 may be connected to other core networks. The communication link between the RAN 2605 the other ASNs may be defined as an R4 reference point, which may include protocols for coordinating the mobility of the WTRUs 2602a, 2602b, 2602c between the RAN 2605 and the other ASNs. The communication link between the core network 2609 and the other core networks may be defined as an R5 reference, which may include protocols for facilitating interworking between home core networks and visited core networks.

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

1-16. (canceled)

17. A method to allocate a resource, the method comprising:
receiving a first message from a first IEEE 802.11 device representing a first group of devices associated with a first provider, wherein the first message includes a first utility metric, and wherein the first utility metric is a performance based metric, and wherein the first IEEE 802.11 device contends for the resource using the first utility metric;
receiving a second message from a second IEEE 802.11 device representing a second group of devices associated with a second provider, wherein the second message includes a second utility metric, and wherein the second utility metric is a performance based metric, and wherein the second IEEE 802.11 device contends for the resource using the second utility metric;
determining a most favorable utility metric, wherein the most favorable utility metric is associated with a most favorable performance based metric;
assigning the resource to a provider associated with the most favorable utility metric; and
receiving contention-based resource requests from a device associated with the provider.

18. The method of claim 17, wherein the first message includes an indication that the first IEEE 802.11 device is a provider coordinator associated with the first provider.

19. The method of claim 18, wherein the indication that the first IEEE 802.11 device is the provider coordinator is provided in an information element, and wherein a first field of the information element identifies an address associated with the provider coordinator, and wherein a second field of the information element identifies the first provider associated with the provider coordinator.

20. The method of claim 17, wherein the first message is received in response to sending a coordination request to the first IEEE 802.11 device, and wherein the coordination request is made via an information element, and wherein the information element identifies a metric to be provided.

21. The method of claim 17, wherein the received contention-based resource requests are legacy contention-based resource requests.

22. The method of claim 17, wherein the resource is access to a primary channel.

23. The method of claim 17, wherein the most favorable utility metric is a metric associated with a network performance associated with the provider, and wherein the network performance comprises at least one of an average throughput or an amount of interference.

24. A network entity comprising:
a processor configured to:
receive a first message from a first IEEE 802.11 device representing a first group of devices associated with a first provider, wherein the first message includes a first utility metric, and wherein the first utility metric is a performance based metric, and wherein the first IEEE 802.11 device contends for a resource using the first utility metric;
receive a second message from a second IEEE 802.11 device representing a second group of devices associated with a second provider, wherein the second message includes a second utility metric, and wherein the second utility metric is a performance based metric, and wherein the second IEEE 802.11 device contends for the resource using the second utility metric;
determine a most favorable utility metric, wherein the most favorable utility metric is associated with a most favorable performance based metric;
assign the resource to a provider associated with the most favorable utility metric; and
receive contention-based resource requests from a device associated with the provider.

25. The network entity of claim 24, wherein the first message includes an indication that the first IEEE 802.11 device is a provider coordinator associated with the first provider.

26. The network entity of claim 25, wherein the indication that the first IEEE 802.11 device is the provider coordinator is provided in an information element, and wherein a first field of the information element identifies an address associated with the provider coordinator, and wherein a second field of the information element identifies the first provider associated with the provider coordinator.

27. The network entity of claim 24, wherein the first message is received in response to sending a coordination request to the first IEEE 802.11 device, and wherein the coordination request is made via an information element, and wherein the information element identifies a metric to be provided.

28. The network entity of claim 24, wherein the most favorable utility metric associated with the provider maps to a clear channel assessment (CCA) threshold, wherein a higher utility metric is provided a higher CCA threshold.

29. The network entity of claim 24, wherein the received contention-based resource requests are legacy contention-based resource requests.

30. The network entity of claim 24, wherein the resource comprises access to a primary channel.

31. The network entity of claim 24, wherein the most favorable utility metric is a metric associated with a network performance associated with the provider.
